(19) United States
(12) Patent Application Publication
(10) Pub. No.: US 2011/0185222 A1
(43) Pub. Date: Jul. 28, 2011

(54) STORAGE DEVICE, CONTROL DEVICE, AND CONTROL METHOD FOR STORAGE DEVICE

(75) Inventor: Zhongzhong MIN, Kawasaki (JP)

(73) Assignee: FUJITSU LIMITED, Kawasaki-shi (JP)

(21) Appl. No.: 13/006,700

(22) Filed: Jan. 14, 2011

(30) Foreign Application Priority Data
Jan. 22, 2010 (JP) 2010-012345

(51) Int. Cl. G06F 11/16; G06F 11/20

(52) U.S. Cl. 714/6.3; 714/E11.091

(57) ABSTRACT

A storage device includes first-storage-module having a storage region for storing data transmitted from a higher-order-device, a plurality of second-storage-module temporarily storing data, reception-processing-module receiving data transmitted from the higher-order-device, first-storage-processing-module storing data received from the higher-order-device in the first-storage-module and storing data received from the higher-order-device in the second-storage-module following the order of reception, data-group-output-module outputting a data group including data stored in each of second-storage-module, data-group-storage-region-securing-module detecting an abnormality in output processing by the data-group-output-module and securing a data-group-storage-region for storing the data group in the first-storage-module or third-storage-module, evacuation-processing-module reading out the data group from the second-storage-module and evacuating to the data-group-storage-region depending on the usage state of the second-storage-module, and second-storage-processing-module storing the data group evacuated to the data-group-storage-region in each storage region of the second-storage-module which have become available due to output processing by the data-group-output-module having been completed.

### CROSS-REFERENCE TO RELATED APPLICATION

This application is based upon and claims the benefit of priority of the prior Japanese Patent Application No. 2010-012345, filed on Jan. 22, 2010, the entire contents of which are incorporated herein by reference.

### FIELD

The embodiment discussed herein is related to a storage device having order-guaranteed asynchronous copy functions, a control device, and a control method for the storage device.

### BACKGROUND

Heretofore, with RAID (Redundant Arrays of Inexpensive Disks) using distributed cache memory type storage systems, redundant configurations including multiple control modules for controlling input/output of data as to storage have been employed, in order to improve capabilities and reliability. Each control module performs read/write processing of data as to a logical volume.

Such RAID devices have an order-guaranteed remote copy function called “advanced copy”. FIG. 38 is a diagram for describing a RAID device having an order-guaranteed remote copy function. The storage system shown in FIG. 38 has a RAID device 3801 having control modules #00 and #01, and a RAID device 3802 having control modules #10 and #11.

Description is made regarding a case of performing a remote copy from the RAID device 3801 to the RAID device 3802. The RAID device 3801 is referred to as a “copy source device”, and the RAID device 3802 as a “copy destination device”.

Each RAID device has recording dedicated buffers including a buffer and a BIT (Buffer Index Table) storage unit, buffer set information storage units for storing information relating to buffer sets, and storage media for storing data.

A buffer is divided into multiple regions of a certain size. A buffer ID is assigned for each of the divided regions of the buffer. Each region temporarily stores data which has been stored in the storage media or is to be stored in the storage media. The BIT storage unit stores a BIT which is information including the storage location of data stored in the buffer, and in the case in FIG. 38, the buffer ID, and so forth.

Note that (0000) described in the buffer in FIG. 38 represents buffer data stored in a buffer of which the buffer ID is 0000. Also, 0000 described in the BIT storage region represents the buffer ID of the buffer for storing the buffer data.

The buffer set information storage unit stores combinations of buffer data stored in the buffers of each control module, e.g., information relating to a buffer set which is a combination of the buffer data (0000) and (0100) surrounded by the dotted lines in a rectangular form long in the horizontal direction.

Information relating to this buffer set includes correlation information regarding each buffer data which the copy source device 3801 stores and the buffer of the copy destination device 3802 storing each buffer data. For example, the buffer data stored in the buffer of which the buffer ID is 0000, and the buffer of which the buffer ID is 1000 which stores that buffer data, are correlated at the buffer set information storage unit of the control module #00.

In the above configuration, (a) upon accepting a write I/O command from a host computer or the like, the control modules #00 and #01 store write data in the storage media, in accordance with the write I/O command. At the same time, (b) the control modules #00 and #01 store the write data, stored in the storage media, in buffers relating to the control modules #00 and #01. At this time, the write data is managed in increments of buffer sets.

Subsequently, (c) upon writing of the write data to the buffer, the control modules #00 and #01 start data transfer of the write data written to the buffers, i.e., start remote copy.

(d) The write data sent from the copy source device 3801 is stored in the control modules #10 and #11 of the copy destination device 3802. The control modules #10 and #11 store the write data stored in buffers in the recording media.

Upon the above-described processing being completed, (e) the control modules of the copy source device 3801 and copy destination device 3802 release the buffers and so forth.

Thus, order is guaranteed by centrally controlling buffer sets by performing data transmission with a bucketed system using recording dedicated buffers.

While description has been made regarding remote copying from RAID device 3801 to RAID device 3802 in FIG. 38, the same processing is performed for remote copying from RAID device 3802 to RAID device 3801 as well. In this case, the RAID device 3802 is the copy source device and the RAID device 3801 is the copy destination device.

In relation with the above technology, there is known a backup device wherein the usage state of a buffer for temporarily storing write data is monitored, with information within the buffer being written to a high-speed disk system in the event that the empty space of the buffer is almost all used up, and being written back to the buffer when the usage state is more favorable.

There is also known a database recovery method wherein, in the event that a first system fails, the first system is switched to a second system, and also a second calculator where a second database management system runs is added to the second system, following which a sub-database which has recovered or is being recovered with a subset is handed over.

Japanese Laid-Open Patent Publication No. 2006-268420 and Japanese Laid-Open Patent Publication No. 2006-004147 are examples of related art.

However, as shown in FIG. 39, at the copy source device 3801, the buffers storing write data that has been transferred and the BIT are not released and continue to hold information, until the write data is loaded to the storage media at the copy destination device 3802.

Accordingly, (f) in the event that the processing of loading the write data to the storage media is delayed at the copy destination device 3802, or the line performance between the copy source device 3801 and the copy destination device 3802 is low or imbalanced, or the like, the transfer processing of the write data may be delayed.

For example, in the event that there is a delay in the transfer processing of the write data due to low bandwidth or instability in the line between the copy source device 3801 and the copy destination device 3802, the time that the copy source device 3801 and the copy destination device 3802 use the buffers and BITs is longer by a corresponding amount of time, so the buffers cannot be released during that time.

(g) Upon receiving a new write I/O command from the host computer or the like in such a state, the copy source device 3801 stores the write data in the buffer each time a write I/O command is received. As a result the buffers of the copy source device 3801 continue to be consumed.

(h) If such a state continues, buffers capable of storing write data cannot be secured any more at the copy source device 3801, so the buffers of the copy source device 3801 are depleted. Also, in the case of processing write data of a size greater than the set buffer size, the buffers of the copy source device 3801 are depleted.

In a state of buffers being depleted, the copy source device 3801 does not process write I/O commands from the host computer or the like and data transfer is stopped, so this state cannot continue for long.

Accordingly, in the event that the buffer depletion state is not resolved even if write I/O command processing is temporarily stopped and a certain amount of time passes, buffer halt processing, where the contents of the buffers are cleared, is performed. Note that part or all of the data stored in the recording dedicated buffers and buffer sets may be subject to halt processing. The copy source device 3801 and the copy destination device 3802 perform buffer halt processing, so as to clear the buffers and resume the write I/O command processing.

At this time, the copy source device 3801 writes the information of write data and the like in the buffers back to a dedicated bitmap. The copy source device 3801 then performs remote copy transfer with order not guaranteed, following the bitmap after having performed the buffer halt processing. In this case there is a problem that order-guaranteed remote copying is interrupted.

### SUMMARY

According to one aspect of the present storage device, the present storage device includes the following components. First storage module storage module having a storage region for storing data transmitted from a higher level device. Also, second storage modules are storage module which temporarily store data.

Reception processing module receive data transmitted from the higher level device. First storage processing module store data received from the higher level device in the first storage module, and also store data received from the higher level device in the second storage modules in a distributed manner following the order of reception.

Data group output module output a data group including data stored in each of the plurality of second storage modules, in batch fashion. Upon detecting an abnormality in output processing by the data group output module, data group storage region securing module secure a data group storage region for storing the data group in the first storage module or third storage module.

Evacuation processing module read out the data group from the second storage modules and evacuate to the data group storage region, depending on the usage state of the second storage modules.

Second storage processing module store the data group, which has been evacuated to the data group storage region, in a distributed manner in each storage region of the second storage modules which have become available due to output processing by the data group output module having been completed.

According to the present storage device, a storage device, a control device, and a control method for the storage device, capable of performing order-guaranteed remote copying even in cases wherein there is delay in data transfer processing, can be provided.

### BRIEF DESCRIPTION OF DRAWINGS

FIG. 1 is a diagram illustrating the overview of the configuration of storage according to an embodiment of the present application;

FIG. 2 is a diagram illustrating a specific configuration example of memory which a control module according to the embodiment has;

FIG. 3 is a diagram illustrating a configuration example of a buffer management table according to the embodiment;

FIG. 4 is a diagram illustrating a configuration example of a buffer set management table according to the embodiment;

FIG. 5 is a diagram illustrating a configuration example of an evacuation buffer management table according to the embodiment;

FIG. 6 is a diagram illustrating a configuration example of a disk device management table according to the embodiment;

FIG. 7 is a diagram illustrating the overview of Snap OPC+according to the embodiment;

FIG. 8 is a diagram illustrating a configuration example of a pool management table for Snap OPC+according to the embodiment;

FIG. 9 is a diagram illustrating the overview of Thin Provisioning according to the embodiment;

FIG. 10 is a diagram illustrating a configuration example of a pool management table for Thin Provisioning according to the embodiment;

FIG. 11 is a diagram illustrating a configuration example of a disk device bitmap according to the embodiment;

FIG. 12 is a diagram illustrating a configuration example of an evacuation buffer bitmap according to the embodiment;

FIG. 13 is a diagram illustrating a configuration example of update history information according to the embodiment;

FIG. 14 is a diagram illustrating a configuration example of an evacuation buffer according to the embodiment;

FIG. 15 is a diagram illustrating a configuration example of an evacuation buffer according to the embodiment;

FIG. 16 is a diagram illustrating a configuration example of an evacuation buffer according to the embodiment;

FIG. 17 is a diagram for describing buffer evacuation processing according to the embodiment;

FIG. 18 is a diagram for describing buffer evacuation processing according to the embodiment;

FIG. 19 is a flowchart illustrating the overview of processing with a storage system according to the embodiment;

FIG. 20A is a flowchart illustrating the overview of forward remote copying (steps S1901 and S1902) according to the embodiment;

FIG. 20B is a flowchart illustrating the overview of forward remote copying (steps S1901 and S1902) according to the embodiment;

FIG. 21 is a flowchart illustrating processing for generating an evacuation buffer region according to the embodiment;

FIG. 22 is a flowchart illustrating specific processing for appropriating evacuation buffers to control modules (step S2107) according to the embodiment;

FIG. 23 is a diagram illustrating the overview of storage processing to individual buffers (step 52005a) according to the embodiment;

FIG. 24 is a flowchart illustrating storage processing to individual buffers (step 52005a) according to the embodiment;

FIG. 25 is a flowchart illustrating buffer set switchover processing according to the embodiment;

FIG. 26 is a diagram describing write-back pointer information/stage pointer information in the buffer evacuation processing according to the embodiment;

FIG. 27 is a flowchart illustrating write-back pointer information updating processing according to the embodiment;

FIG. 28 is a flowchart illustrating stage pointer information updating processing according to the embodiment;

FIG. 29 is a flowchart illustrating write-back according to the embodiment;

FIG. 30 is a diagram illustrating a specific example of write-back according to the embodiment;

FIG. 31 is a diagram illustrating a specific example of write-back according to the embodiment;

FIG. 32A is a flowchart illustrating staging according to the embodiment;

FIG. 32B is a flowchart illustrating staging according to the embodiment;

FIG. 33 is a flowchart illustrating specific processing in the matching processing (step S2012a) illustrated in FIG. 20B;

FIG. 34 is a flowchart illustrating processing of a secondary device securing en evacuation buffer (step S1908) at the time of reverse remote copy according to the embodiment;

FIG. 35 is a flowchart illustrating read processing at the secondary device according to the embodiment;

FIG. 36 is a diagram illustrating the overview of write processing at the secondary device according to the embodiment;

FIG. 37 is a flowchart illustrating write processing at the secondary device according to the embodiment;

FIG. 38 is a diagram illustrating a conventional example of a RAID device having order-guaranteed remote copy functions; and

FIG. 39 is a diagram illustrating a conventional example of a RAID device having order-guaranteed remote copy functions.

### DESCRIPTION OF EMBODIMENTS

Examples of an embodiment are described below with reference to

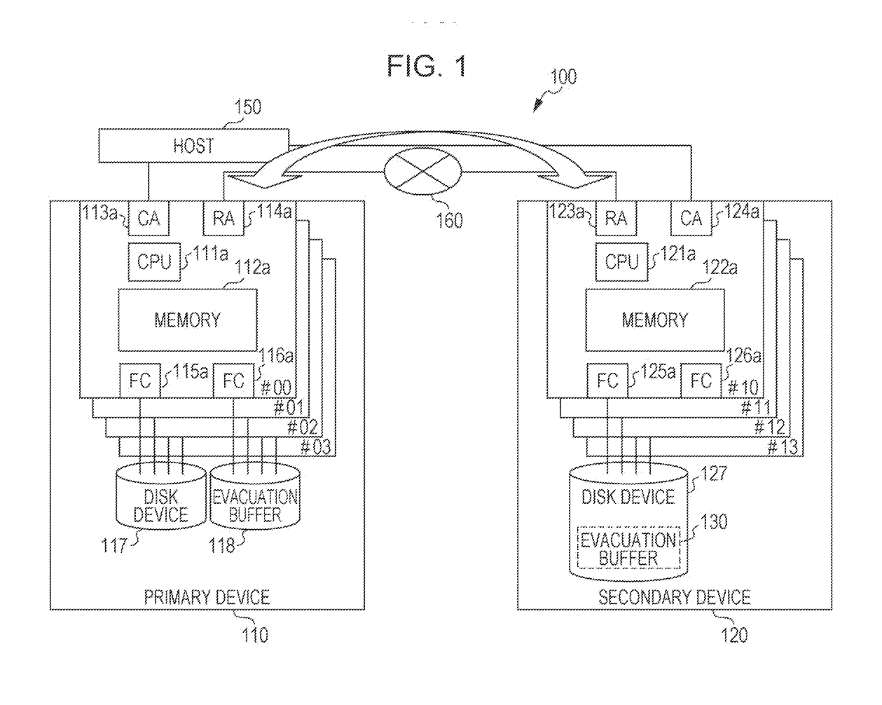

FIGS. 1 to 37. FIG. 1 is a diagram illustrating the overview of the configuration of storage system 100 according to the present embodiment. A storage system 100 shown in FIG. 1 includes a RAID device 110, a RAID device 120 communicably connected to the RAID device 110 via a network or a dedicated line 160.

The RAID device 110 is a distributed cache memory type RAID device including control modules #00 through #03 having memory used for cache memory and so forth, a disk device 117 configured of a storage device such as a magnetic disk device or the like, and an evacuation buffer 118.

The control modules #00 through #03 are connected to the disk device 117 and evacuation buffer 118.

For example, the control module #00 includes a CPU (Central Processing Unit) 111a, memory 112a, a CA (Channel Adapter) 113a, an RA (Remote Adapter) 114a, and FCs (Fiber Channels) 115a and 116a.

Note that with the present embodiment, the control modules #01, #02, and #03 also have the same configuration as with the control module #00. That is to say, the control module #01 has a CPU 111b, memory 112b, CA 113b, RA 114b, and FCs 115b and 116b. Also, the control module #02 has a CPU 111c, memory 112c, CA 113c, RA 114c, and FCs 115c and 116c. The control module #03 has a CPU 111d, memory 112d, CA 113d, RA 114d, and FCs 115d and 116d. The configuration of the control module #00 is described, representing the control modules.

The CPU 111a realizes order-guaranteed remote copying according to the present embodiment by executing predetermined program commands to cause the control module #00 to operate.

The memory 112a is a memory used for, in addition to cache memory, a later-described recording dedicated buffer 201 and buffer set information storage unit 202 and so forth.

The CA 113a is an interface control unit as to a host 150 which is a host computer connected to the RAID device 110. Also, the RA 114a is an interface control unit as to another RAID device connected via a network or the dedicated line 160.

The FCs 115a and 116a are interface control units as to the disk device 117 and evacuation buffer 118. With the present embodiment, the FC 115a connects to the disk device 117 and the FC 116a connects to the evacuation buffer 118.

The disk device 117 and the evacuation buffer 118 are storage devices having one or multiple storage devices, such as magnetic disk devices, for example.

The RAID device 120 is a distributed cache memory type RAID device including control modules #10 through #13 having memory used for cache memory and so forth, a disk device 127 configured of a storage device such as a magnetic disk device or the like, and a disk device 127 configured of a storage device such as a magnetic disk device or the like.

The control modules #10 through #13 of the RAID device 120 are of the same configuration as the control modules #00 through #03 of the RAID device 110.

The disk device 127 is a storage device having one or multiple storage devices, such as magnetic disk devices, for example. Note that the disk device 127 may be realized in a virtual manner, as needed. In this case, a pool for a disk device to provide a virtual storage region for the virtually-realized disk device 127 is also needed. The later-described pool for Thin Provisioning or pool for SnapOPC+ may be used as a pool for a disk device.

Also, the disk device 127 may include an evacuation buffer 130 as needed. In this case, the evacuation buffer 130 may be configured using a part of the storage device relating to the disk device 127. Note that the evacuation buffer 130 may be a device independent from the disk device 127, in the same way as with the evacuation buffer 118.

In the above configuration, buffer set data may be used as a “data group”.

Also, “first storage module” may be realized using part or all of the disk devices 117 and 127 configured of one or multiple magnetic disk devices or the like. “Second storage module” may be realized using part of the memory 112a through 112d and 122a through 122d. A “data group storage region” may be realized using part or all of the evacuation buffer 118 and disk device 127.

“Reception module” may be realized by executing a program which the CPU 111a or the like has loaded to the memory 112a or the like, or by executing a program which the CPU 121a or the like has loaded to the memory 122a or the like. Also, “first storage processing module”, “data group output module”, “data group storage region securing module”, “evacuation processing module”, and second storage processing module” and so forth may be realized by the CPU 111a or the like executing program commands.

While FIG. 1 illustrates a case in which the RAID device 110 and RAID device 120 have four control modules, this illustration is not intended to be interpreted restrictively. It is sufficient that the RAID device 110 and the RAID device 120 be distributed cache memory type RAID devices. The numbers of CPUs, CAs, RAs, and DAs are also not restricted to the numbers illustrated in FIG. 1.

In the following description, the RAID device 110 is referred to as “primary device 110”, and the RAID device 120 is referred to as “secondary device 120”.

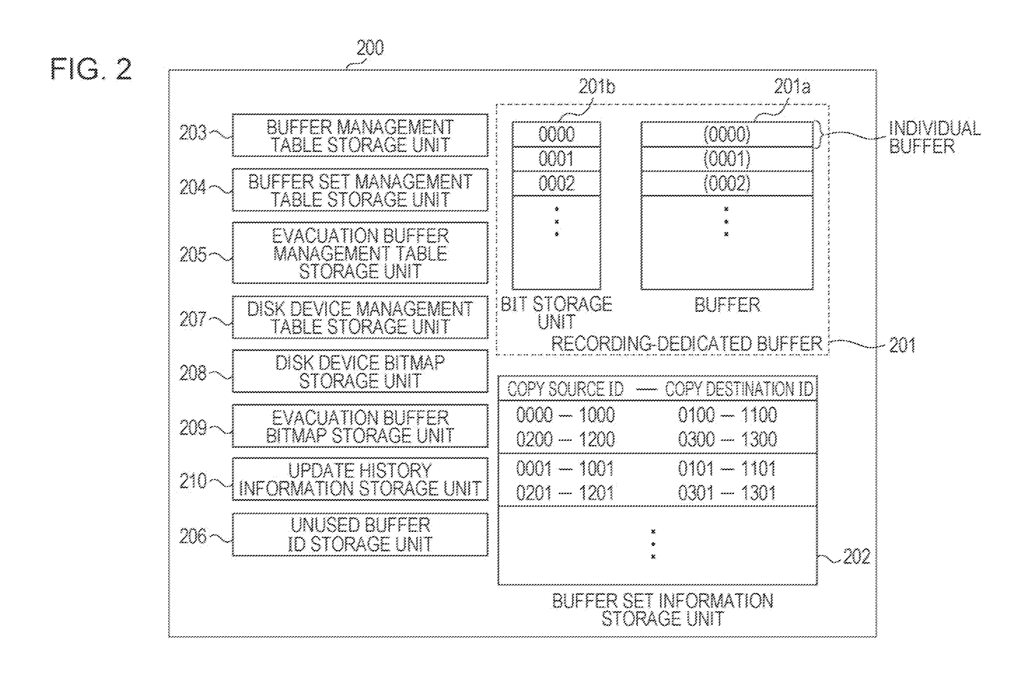

FIG. 2 is a diagram illustrating a configuration of memory 200 which a control module according to the present embodiment has, e.g., memory 112a which the control module #00 of the RAID device 110 has.

The memory 112b, 112c, and 112d of the control module #01 through #03 of the RAID device 110, and the memory 122a, 122b, 122c, and 122d of the control module #10 through #13 of the RAID device 120 may also be of the same configuration as that in FIG. 2.

The memory 200 in FIG. 2 has a recording dedicated buffer 201 and a buffer set information storage unit 202. Also, the memory 200 has a buffer management table storage unit 203, a buffer set management table storage unit 204, an evacuation buffer management table storage unit 205, and an unused buffer ID storage unit 206. Further, the memory 200 has a disk device management table storage unit 207, a disk device bitmap storage unit 208, an evacuation buffer bitmap storage unit 209, and an update history information storage unit 210.

The recording dedicated buffer 201 has a buffer 201a and a BIT storage unit 201b. The buffer 201a temporarily stores data stored in, or to be stored in the disk device 117 or the like, e.g., later-described write data or the like. The buffer 201a according to the present embodiment is sectioned into eight regions having a certain size. Unique identification information is appropriated to each of the sectioned regions. Note that while a case is exemplified in the present embodiment where the buffer 201a is sectioned into eight regions, this illustration is not intended to restrict the buffer 201a to being sectioned into eight regions.

Hereinafter, these sectioned regions are referred to as “individual buffers”. Also, identification information appropriated to the individual buffers are referred to as “buffer IDs”. Data stored in the individual buffers is referred to as “buffer data”.

For example, with regard to the (0000), (0001), (0002), and so on described in the buffer 201a in FIG. 2, the numerals 0000, 0001, 0002, and so on within the parentheses represent buffer IDs appropriated to each individual buffer. The numerals (0000), (0001), (0002), and so on with parentheses mean buffer data stored in the individual buffers indicated by the buffer IDs within the parentheses.

The BIT storage unit 201b stores a BIT including the LU (Logical Unit) and LBA (Logical Block Address) to which the buffer data stored in individual buffers in the buffer 201a is loaded to, data size, copy session No., and so forth.

The 0000, 0001, 0002, and so on in the BIT storage unit 201b represent the buffer ID appropriated to each individual buffer within the buffer 201a. For example, the 0000 within the BIT storage unit 201b stores a BIT including the LU and LBA to which the buffer data stored in the individual buffer with the buffer ID 0000 is loaded to, data size, copy session No., and so forth.

The buffer set information storage unit 202 stores identification information indicating a buffer set which a combination of individual buffers of the control module within the same RAID device, i.e., stores a later-descried buffer set ID.

Hereinafter, information relating to a buffer set is referred to as “buffer set information”. Also, buffer data stored in a buffer set is collectively referred to as “buffer set data”.

With the present embodiment, there are eight individual buffers provided to the buffer 201a of each control module, so the number of buffer sets is also eight. To simplify description, we say that buffer set IDs are the same as buffer IDs of the individual buffer of a later-described master control module.

Buffer set information includes information correlating individual buffers which a control module mounted to the primary device 110 has, and individual buffers which a control module mounted to the second device 120 has. Processing for including this correlating information in the buffer set information is called “matching processing”.

Hereinafter, in the case of performing a remote copy from the primary device 110 to the secondary device 120, the buffer ID of an individual buffer relating to a control module mounted to the primary device 110 is referred to as a “copy source ID”, and the buffer ID of an individual buffer relating to a control module mounted to the secondary device 120 is referred to as a “copy destination ID”.

In the event of performing a remote copy from the secondary device 120 to the primary device 110, the buffer ID of an individual buffer relating to a control module mounted to the secondary device 120 is the “copy source ID”, and the buffer ID of an individual buffer relating to a control module mounted to the primary device 110 is the “copy destination ID”.

For example, the RAID device 110 is a distributed cache memory type RAID device, and accordingly data such as write data is stored in a distributed manner in individual buffers of the control module, which are the individual buffers with buffer IDs 0000, 0001, 0002, and 0003 in the example in FIG. 2.

In this case, buffer set information representing buffer sets including individual buffers with buffer IDs 0000, 0001, 0002, and 0003 is stored.

The buffer set information includes combination information that the copy source IDs and copy destination IDs are 0000 and 1000, 0100 and 1100, 0200 and 1200, and 0300 and 1300, respectively, for example.

Note that the buffer IDs 0000, 0001, 0002, and 0003 illustrated in the buffer set information storage unit 202 are exemplary illustrates of individual buffers belonging to the control modules #00, #01, #02, and #03 each mounted to the primary device 110. In the same way, the buffer IDs 1100, 1100, 1200 , and 1300 illustrated in the buffer set information storage unit 202 are exemplary illustrates of individual buffers belonging to the control modules #10, #11, #12, and #13 each mounted to the secondary device 120.

Remote copying according to the present embodiment is performed in increments of buffer sets. Data which is the object of copying in increments of buffer sets includes the BIT and buffer table stored in the recording dedicated buffer 201, and the buffer set information stored in the buffer set information storage unit 202.

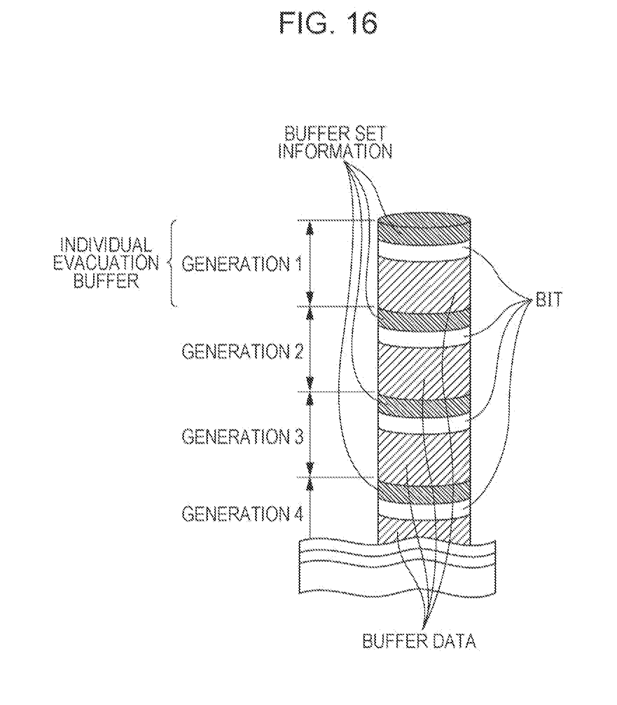

With the present embodiment, a data which is the object of copying in increments of buffer sets is managed as a “generation”. A specific example of generations is illustrated in FIG. 16.

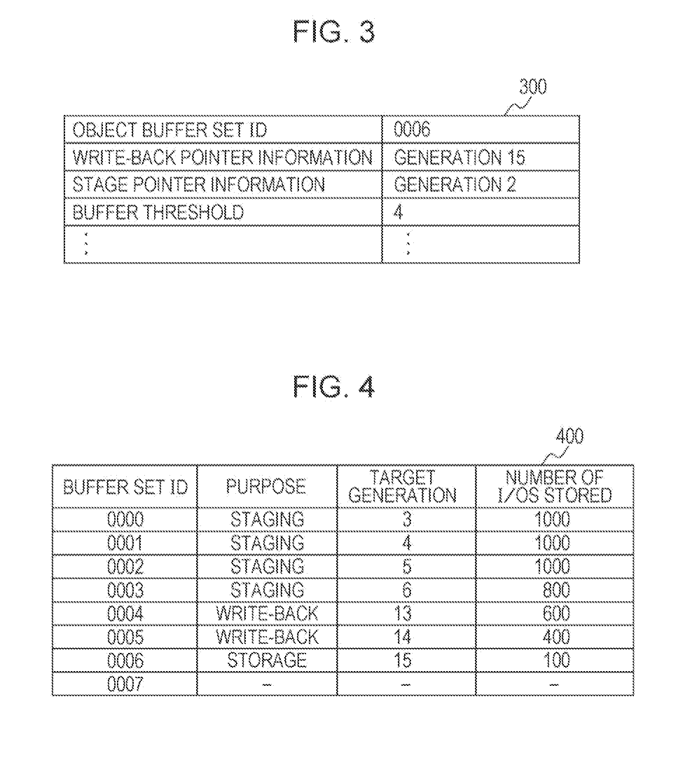

The buffer management table storage unit 203 stores a buffer management table 300 (FIG. 3) used for managing the recording dedicated buffer 201 and the like. The buffer management table 300 is described later.

The buffer set management table storage unit 204 stores a buffer set management table 400 (see FIG. 4) used for managing the usage state of buffer sets. The buffer set management table 400 is described later.

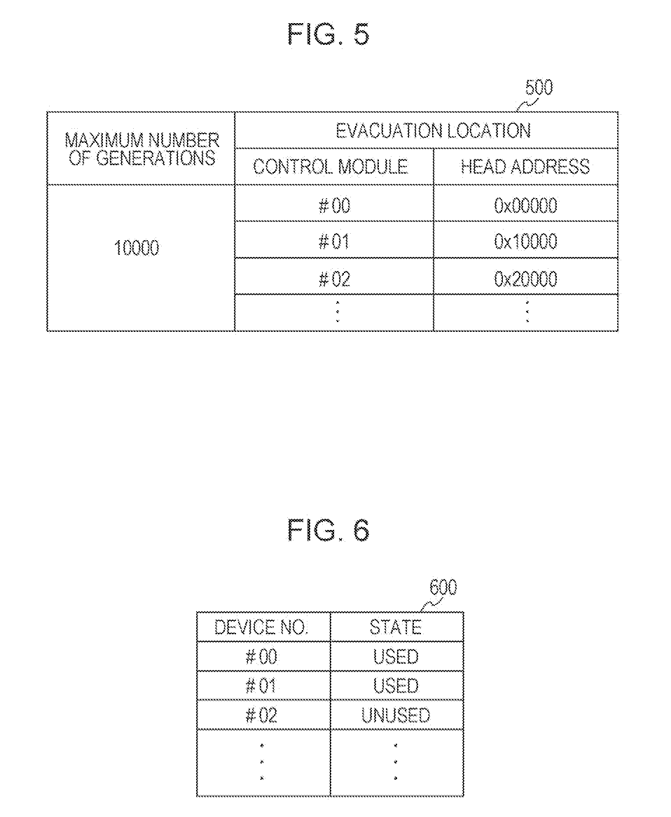

The evacuation buffer management table storage unit 205 stores an evacuation buffer management table 500 (see FIG. 5) used for managing evacuation buffer 118. The evacuation buffer management table 500 is described later.

The unused buffer ID storage unit 206 stores the buffer IDs of unused individual buffers of the secondary device 120 in the event of performing remote copying from the primary device 110 to the secondary device 120, for example. Hereinafter, the buffer ID of an unused individual buffer is referred to as an “unused buffer ID”. For example, in a case of performing a remote copy from the primary device 110 to the secondary device 120, upon receiving a notification of an unused buffer ID from the secondary device 120 the primary device 110 stores the notified unused buffer ID to the unused buffer ID storage unit 206.

The disk device management table storage unit 207 stores a disk device management table 600 (see FIG. 6) used for managing the usage state of each of the storage devices of the disk devices 117 or 127 of its own RAID device. In the event of realizing the disk devices 117 or 127 in a virtual manner, the disk device management table storage unit 207 stores a pool for SnapOPC (One Point Copy) +management table 800 (see FIG. 8) or a pool for Thin Provisioning management table 1000 or the like. The disk device management table 600, pool for SnapOPC+management table 800, and pool for Thin Provisioning management table 1000 is described later.

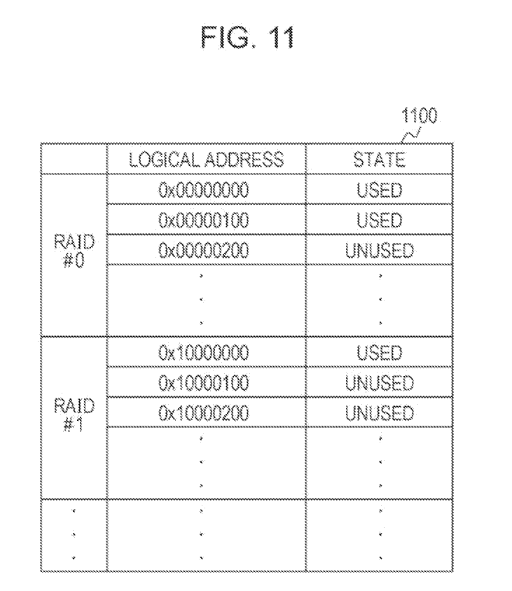

The disk device bitmap storage unit 208 stores a disk device bitmap 1100 (se FIG. 11) used for managing the usage state of storage region of the disk devices 117 or 127 of its own RAID device. The disk device bitmap 1100 is described later.

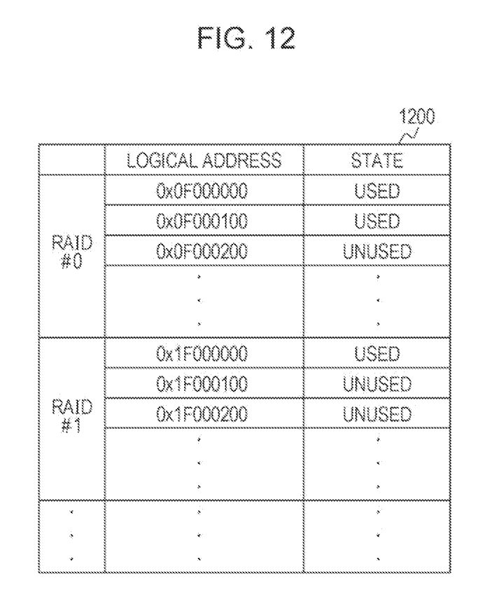

The evacuation buffer bitmap storage unit 209 stores an evacuation buffer bitmap 1200 (see FIG. 12) used for managing the usage state of storage region of the evacuation buffer 130 secured at the evacuation buffer 118 or disk device 127. The evacuation buffer bitmap 1200 is described later.

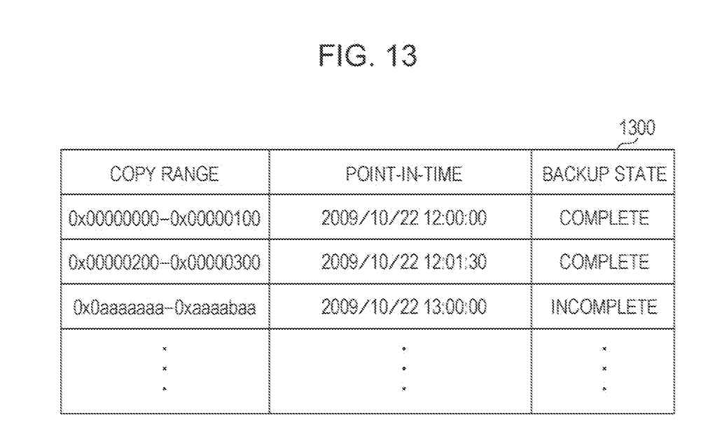

The update history information storage unit 210 stores update history information 1300 (FIG. 13) of data stored in the storage region of the disk devices 117 or 127 of its own RAID device. The update history information 1300 is described later.

Let us consider a case of performing a remote copy form the primary device 110 to the secondary device 120 with the configuration described above. In this case, the primary device 110 performs storage of write data to the recording dedicated buffer 201, transfer of write data to the secondary device 120, and so forth, in batch fashion in increments of buffer sets. The secondary device 120 performs processing such as loading the write data transferred from the primary device 110 to the disk device 127 in batch fashion in increments of buffer sets. As a result, order-guaranteed remote copying is realized.

Note that remote copying in which buffer sets are used to guarantee order is a known art, and is disclosed in, for example, Japanese Laid-Open Patent Publication No. 2006-260292. Also, SnapOPC+is a known art disclosed in, for example, Japanese Laid-Open Patent Publication No. 2009-146228. Similarly, Thin Provisioning is also a known art.

FIG. 3 is a diagram illustrating a configuration example of the buffer management table 300 according to the present embodiment. The buffer management table 300 stores an object buffer set ID, write-back pointer information, stage pointer information, and a buffer threshold, in a correlated manner.

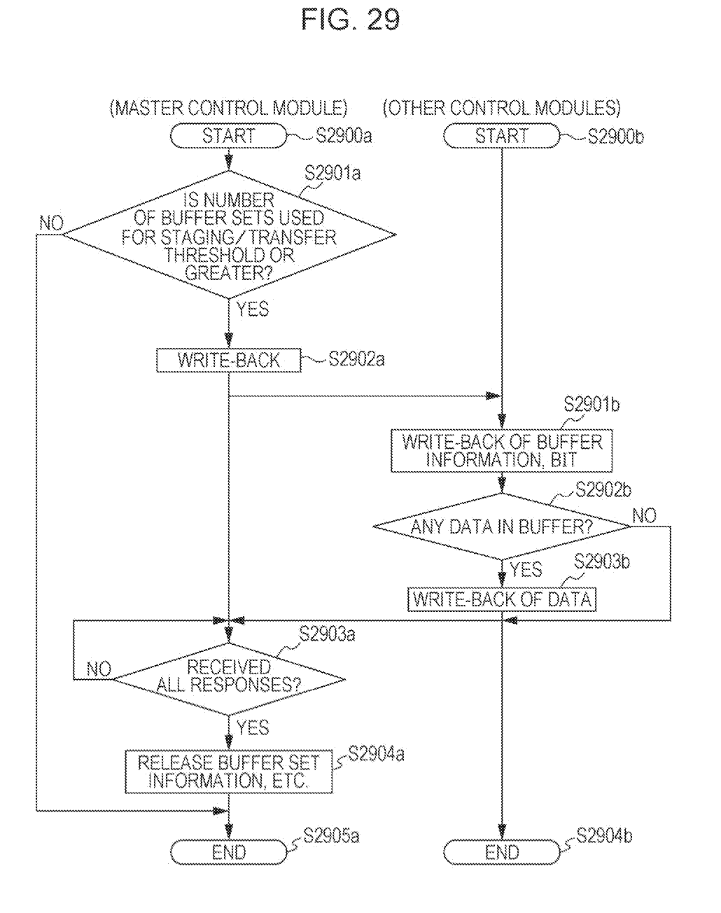

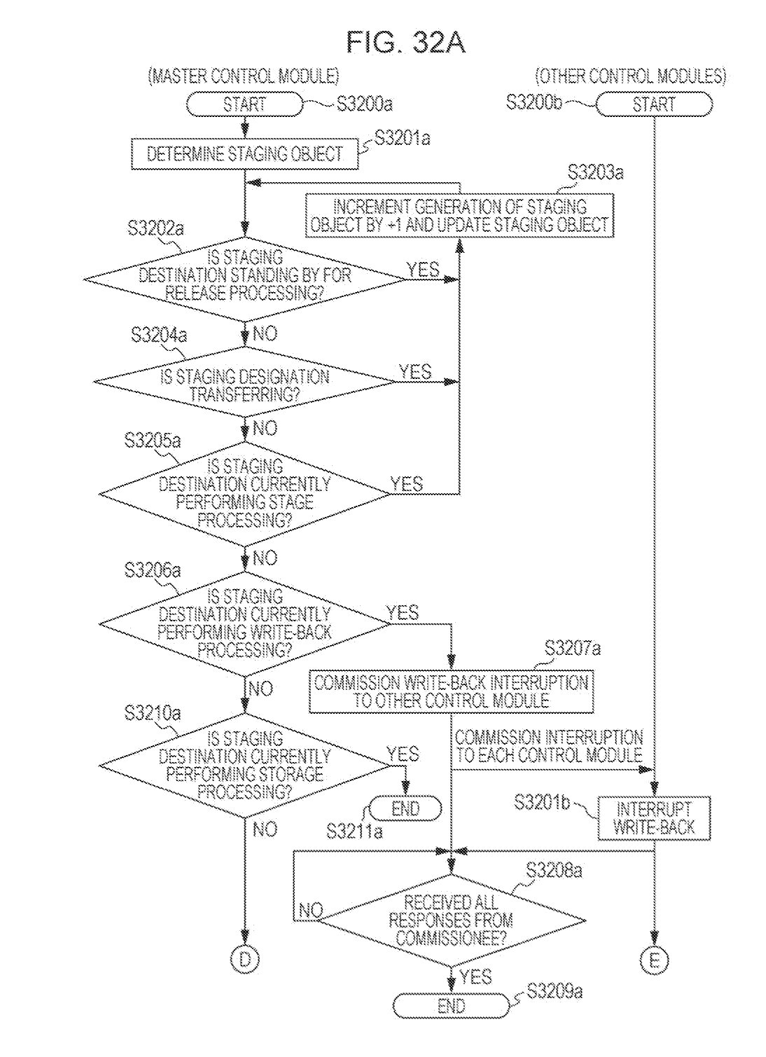

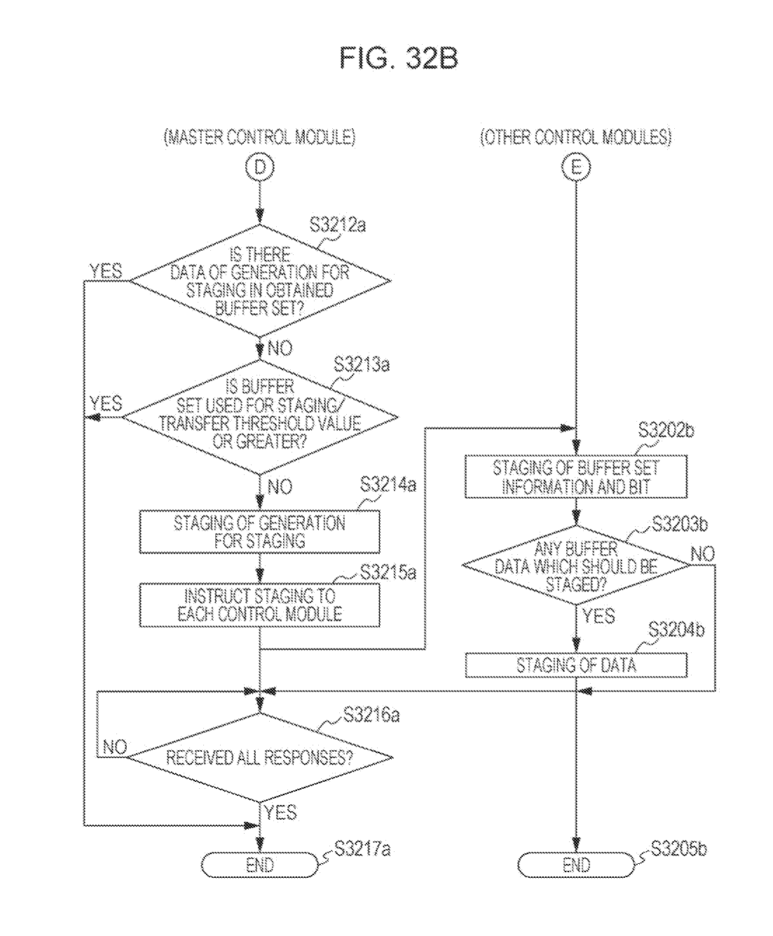

The object buffer set ID is information indicating the buffer set ID of the buffer set currently being used. The write-back pointer information is information indicating the generation which is the object of write-back in FIG. 29. The stage pointer information is information indicating the generation regarding which the staging shown in FIGS. 32A and 32B has been performed.

FIG. 4 is a diagram illustrating a configuration example of the buffer set management table 400 according to the present embodiment. The buffer set management table 400 stores the buffer set ID, purpose, target generation, and number of I/Os stored, in a correlated manner.

The purpose is information indicating the usage purpose of the buffer set, set beforehand for each buffer set indicated by the buffer set ID. For example, in the event that the buffer set is to be used for staging, “staging” is set, and in the event of being used for write-back, “write-back” is set. Also, in the event of being used for simply storing copy data of the write data in a buffer set, “storage” is set, and in the event of transferring copy data stored in the buffer set to the secondary device 120, “transfer” is set.

The target generation is the generation on which the processing set in the purpose is to be performed. The number of I/Os stored is the number of I/Os stored in the buffer set. The target generation and the number of I/Os stored are updated by the primary device 110 each time write data is stored in a buffer set, for example.

Note that the hyphens “-” in FIG. 4 mean being set to unused.

FIG. 5 is a diagram illustrating a configuration example of the evacuation buffer management table 500 according to the present embodiment.

The evacuation buffer management table 500 stores the maximum number of generations to be copied which can be stored in the evacuation buffer 118, and the evacuation position which is a storage region within the evacuation buffer 118 and is appropriated to each control module, in a correlated manner.

The maximum number of generations is determined at the time of initializing the evacuation buffer 118, or the like.

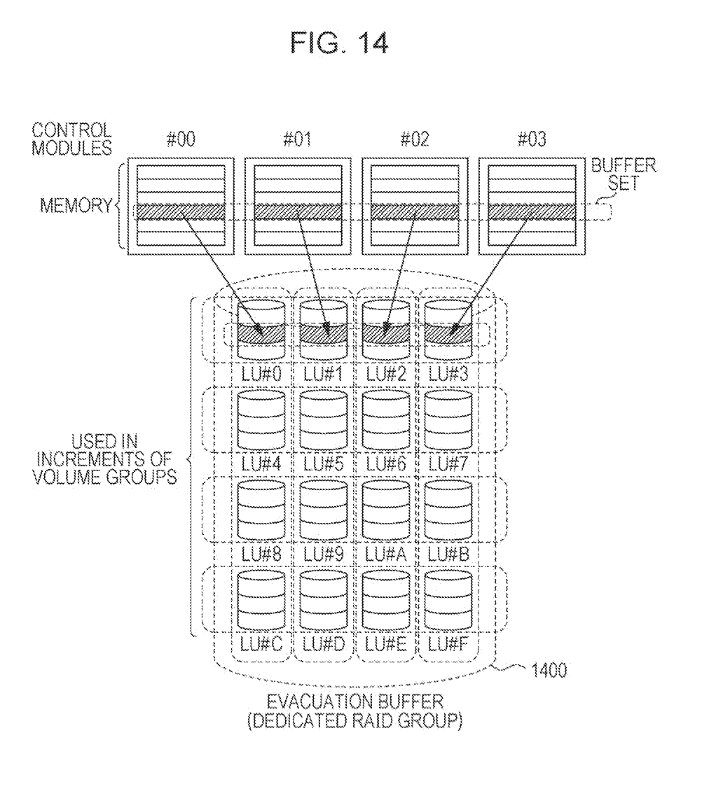

Hereinafter, storage region for one generation, which is storage region appropriated for each control module within the evacuation buffer 118, is referred to as “individual evacuation buffer”. For example, in LU#0 described in FIG. 14, each of the storage regions in which it has been divided is an individual evacuation buffer.

FIG. 6 is a diagram illustrating a configuration example of the disk device management table 600 according to the present embodiment. The disk device management table 600 stores a device No. and state information of the storage device which the device No. indicates, in a correlated manner.

The device No. is an identification No. appropriated to a storage device of the disk device 117 or evacuation buffer 118. Also, state information is information indicating whether or not the storage device which the device No. indicates is being used. In the event that the storage device which the device No. indicates is being used, “used” is set to the state information, and the event that the storage device is not being used, “unused” is set to the state information.

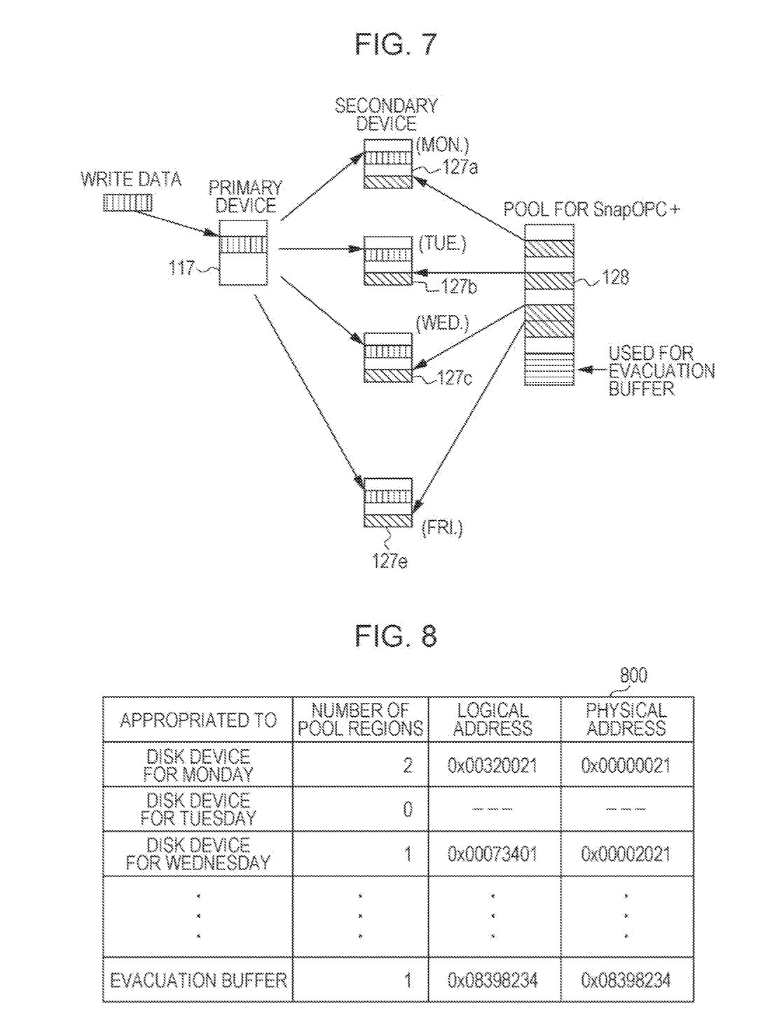

Now, we consider a case wherein the disk device 127 is virtualized to realize SnapOPC+as shown in FIG. 7, for example.

FIG. 7 shows, in a simplified manner, just the disk device 117 of the primary device 110, and a virtualized disk device 127 and pool for SnapOPC+128 of the secondary device 120.

The virtualized disk device 127 has, for example, disk devices 127a, 127b, 127c, and so on through 127e, for every week of the day, for example. Data sent from the primary device 110 on Monday is stored in the virtualized disk device 127a, and data sent from the primary device 110 on Tuesday is stored in the virtualized disk device 127. In the same way, data sent from the primary device 110 on Friday is stored in the virtualized disk device 127e.

The pool for SnapOPC+ 128 is a storage device having a magnetic disk device or the like, for example. The storage region of the pool for SnapOPC+ 128 is appropriated to the disk devices 127a, 127b, 127c, and so on through 127e set to the virtual disk device 127 as needed, in increments of blocks. The pool for SnapOPC+ 128 is managed by the pool for SnapOPC+ management table 800.

FIG. 8 is a diagram illustrating a configuration of the pool for SnapOPC+ management table 800 according to the present embodiment.

The pool for SnapOPC+ management table 800 stores the appropriation target, number of pool regions, logical address, and physical address, in a correlated manner.

The appropriation target is information regarding to which storage region of the pool for SnapOPC+ 128 that appropriation is made. For example, this may be the disk device 127a for Monday, the disk device 127b for Tuesday, the disk device 127c for Wednesday, and so forth. In the event of using part of the storage region as an evacuation buffer, the evacuation buffer is registered to the appropriation target.

The number of pool regions is the number of storage regions in the pool for SnapOPC+ 128 used for appropriation.

The logical address is the logical address of the appropriation targets of the storage regions in the pool for SnapOPC+ 128 used for appropriation.

The physical address is a physical address in the storage region of the pool for SnapOPC+ 128, used for appropriation.

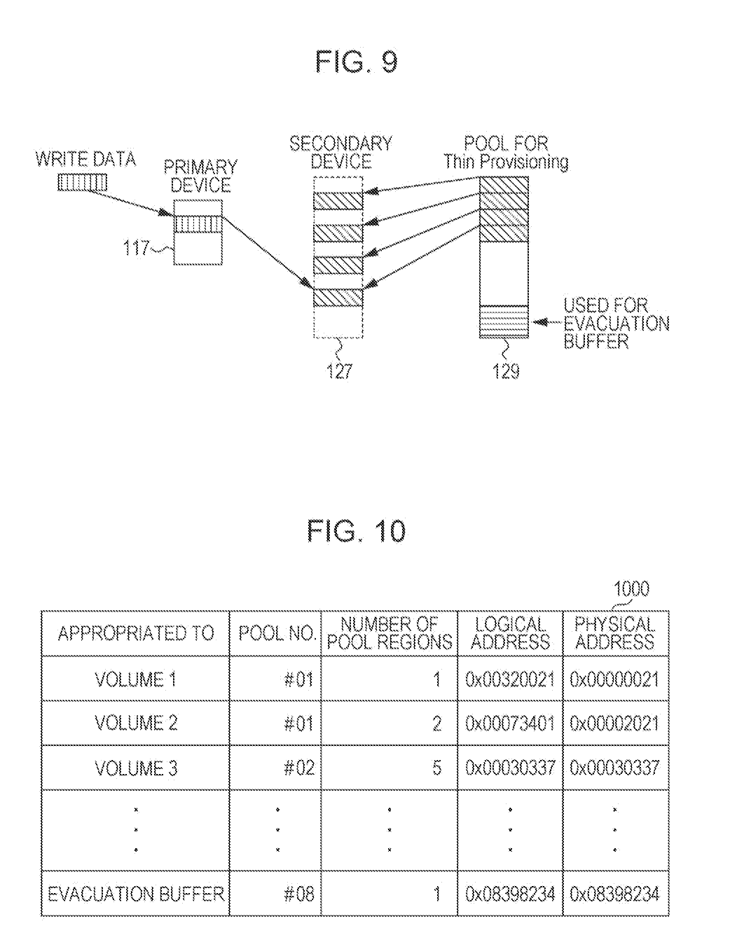

Now, let us consider a case of realizing Thin Provisioning by virtualization of the disk device 127 as shown in FIG. 9, for example.

FIG. 9 shows, in a simplified manner, just the disk device 117 of the primary device 110, and a virtualized disk device 127 and pool for Thin Provisioning 129 of the secondary device 120.

The virtualized disk device 127 has storage region for the pool for Thin Provisioning 129 appropriated to each storage region as needed.

The pool for Thin Provisioning 129 is a storage device having one or multiple storage devices, such as magnetic devices or the like, for example. The storage regions of the pool for Thin Provisioning 129 are appropriated to the virtualized disk device 127 in increments of blocks. The storage regions of the pool for Thin Provisioning 129 are managed by the pool for Thin Provisioning management table 1000 shown in FIG. 10.

FIG. 10 is a diagram illustrating a configuration example of the pool for Thin Provisioning management table 1000 according to the present embodiment.

The pool for Thin Provisioning management table 1000 stores appropriation target, pool No., number of pool regions, logical address, and physical address, in a correlated manner.

The appropriation target is the volume in the storage region of the pool for Thin Provisioning 129 to which appropriation is made.

The pool No. is the No. of the volume to be used for appropriation, of the multiple volumes of the pool for Thin Provisioning 129.

The number of pool regions is the number of storage regions in the pool for Thin Provisioning 129 used for appropriation.

The logical address is the logical address of the appropriation targets of the storage regions in the pool for Thin Provisioning 129 used for appropriation.

The physical address is a physical address in the pool for Thin Provisioning 129, used for appropriation.

FIG. 11 is a diagram illustrating a configuration example of the disk device bitmap 1100 according to the present embodiment.

The disk device bitmap 1100 stores a logical address and state information of one block of storage region which the logical address indicates, in a correlated manner, for each RAID included in the disk device 117 or disk device 127.

State information is information indicating the usage state of the storage region indicated by the logical address. In the event that the storage region which the logical address indicates is being used, “used” is set to the state information, and the event of not being used, “unused” is set to the state information.

FIG. 12 is a diagram illustrating a configuration example of the evacuation buffer bitmap 1200 according to the present embodiment.

The evacuation buffer bitmap 1200 stores a logical address and state information of one block of storage region which the logical address indicates, in a correlated manner, for each RAID included in the evacuation buffer 118.

State information is information indicating the usage state of the storage region indicated by the logical address. In the event that the storage region which the logical address indicates is being used, “used” is set to the state information, and the event of not being used, “unused” is set to the state information.

The evacuation buffer bitmap 1200 can also be used in the event of using a part of the pool for SnapOPC+ 128 or the pool for Thin Provisioning 129 as an evacuation buffer, as well.

FIG. 13 is a diagram illustrating a configuration example of the update history information 1300 according to the present embodiment. The update history information 1300 includes a copy range, point-in-time, and backup state. The copy range is the range of remote copying which has been executed. Also, the point-in-time is the point-in-time at which the remote copying has been executed.

The backup state is information indicating whether or not the same data has been loaded to the disk device 117 of the primary device 110 and the disk device 127 of the secondary device 120.

For example, if the same data has been loaded to the disk device 117 of the primary device 110 and the disk device 127 of the secondary device 120 by remote copying, “complete” is set to the backup state. Also, in the event that remote copying has not been executed yet, or the same data has not been loaded to the disk device 117 of the primary device 110 and the disk device 127 of the secondary device 120 by remote copying, or the like, “incomplete” is set to the backup state.

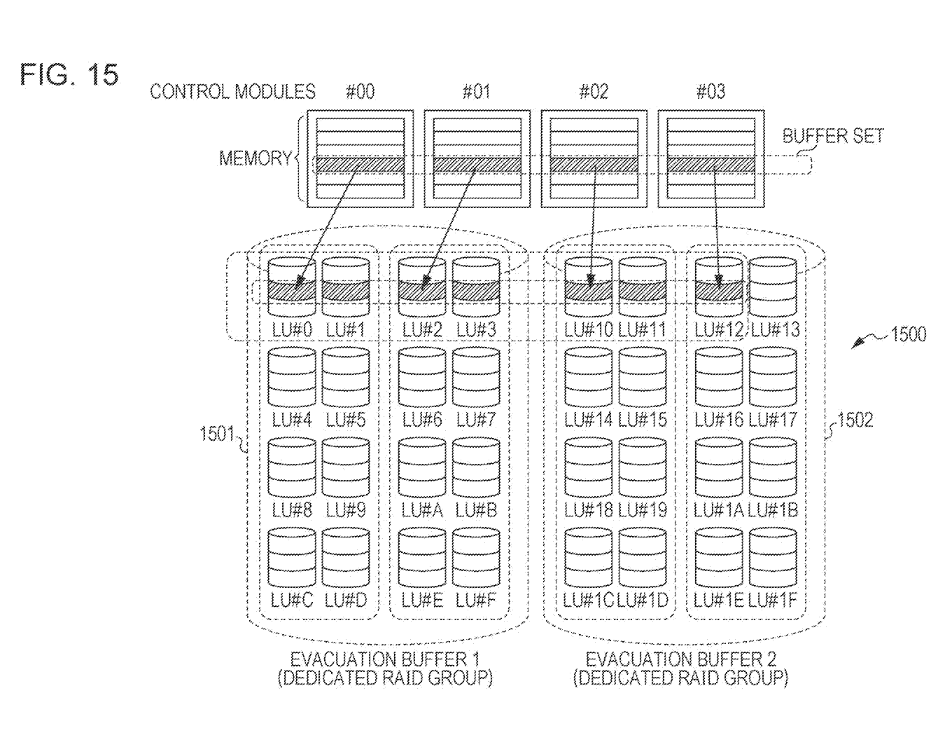

FIGS. 14 and 15 are diagrams illustrating a configuration example of the evacuation buffer 118.

Note that while FIGS. 14 and 15 illustrate a configuration example of the evacuation buffer 118, the evacuation buffer 130 may also have the same configuration. In this case, the evacuation buffer 130 may be realized using part or all of the recording device of the disk device 127. Also, while FIGS. 14 and 15 schematically illustrate the control modules #00 through #03 in a simplified manner in which only the buffer 201a of the recording dedicated buffer 201 is shown, the illustrations in FIGS. 14 and 15 are not intended to be interpreted restrictively.

In FIGS. 14 and 15, the dotted lines traversing the control modules #00 through #03 represent one generation worth of a buffer set.

FIG. 14 is a diagram illustrating a configuration example of configuring the evacuation buffer 118 with one RAID.

A RAID group 1400 used as the evacuation buffer 118 shown in FIG. 14 has logical units LU#0 through LU#F. Also, the LU#0 through LU#3, LU#4 through LU#7, LU#8 through LU#B, and LU#C through LU#F, surrounded by the dotted lines, each make up a volume group.

The RAID group 1400 is used in increments of volume groups. Also, a volume group is appropriated to a recording dedicated buffer for each control module.

For example, in the RAID group 1400 shown in FIG. 14, the logical units LU#0, #4, #8, and #C are appropriated to the recording dedicated buffer of the control module #00. Also, the logical units LU#1, #5, #9, and #D are appropriated to the recording dedicated buffer of the control module #01.

In the same way, the logical units LU#2, #6, #A, and #E are appropriated to the recording dedicated buffer of the control module #02. Also, the logical units LU#3, #7, #B, and #F are appropriated to the recording dedicated buffer of the control module #03.

In the event that the number of logical units making up the volume group exceeds the number of mounted control modules, multiple logical units may be appropriated to one control module. Also, the logical units making up each volume group are divided into sizes with BIT and buffer set information included, in individual buffer increments storing buffer data. These divided regions are the aforementioned “individual evacuation buffers”.

The buffer data stored in the individual buffers of each of the control module is stored in generation order in the individual evacuation buffer of the volume group appropriated to each control module, as shown by the arrows in FIG. 14, for example.

FIG. 15 is a diagram illustrating a configuration example of configuring the evacuation buffer 118 according to the present embodiment with two RAID groups.

A RAID group 1500 used as the evacuation buffer 118 in FIG. 15 is configured of a RAID group 1501 having logical units LU#0 through LU#F, and a RAID group 1502 having logical units LU#10 through LU#1F.

For example, the logical units LU#0, LU#2, LU#10, and LU#12 make up a volume group. Also, the logical units LU#1, LU#3, LU#11, and LU#13 make up a volume group.

In the same way, the logical units LU#4, LU#6, LU#14, and LU#16 make up a volume group, and the logical units LU#5, LU#7, LU#15, and LU#17 make up a volume group. Also, the logical units LU#8, LU#A, LU#18, and LU#1A make up a volume group, and the logical units LU#9, LU#B, LU#19, and LU#1B make up a volume group. Further, the logical units LU#C, LU#E, LU#1C, and LU#1E make up a volume group, and the logical units LU#D, LU#F, LU#1D, and LU#1F make up a volume group.

With the RAID group 1500, logical units within the volume groups are appropriated to recording dedicated buffers for each control module.

For example, in the RAID group 1500 shown in FIG. 15, the logical units LU#0, LU#1, #4, LU#5, #8, LU#9, LU#C, and LU#D are appropriated to the recording dedicated buffer of the control module #00. Also, the logical units LU#2, LU#3, LU#6, LU#7, LU#A, LU#B, LU#E, and LU#F, are appropriated to the recording dedicated buffer of the control module #01.

In the same way, the logical units LU#10, LU#11, #14, LU#15, #18, LU#19, LU#1C, and LU#1D are appropriated to the recording dedicated buffer of the control module #02. Also, the logical units LU#12, LU#13, LU#16, LU#17, LU#1A, LU#1B, LU#1E, and LU#1F, are appropriated to the recording dedicated buffer of the control module #03.

The logical unit making up each volume group is divided into the same size as the individual buffers. The buffer data stored in the individual buffers of each control module is stored in the generation order in the individual evacuation buffers of the volume groups appropriated to the control module, as indicated by the arrows in FIG. 15, for example.

As shown in FIG. 15, appropriating recording dedicating buffers of control module to two or more RAID groups is advantageous in that the load of each RAID group is distributed. Note that while FIG. 15 illustrates a case of two RAID groups being used, it is needless to say that the same advantages may be obtained by using three or more RAID groups.

As described above, an evacuation buffer 118 according to the present embodiment, i.e., the LU#0 through LU#F shown in FIG. 14 and the LU#0 through LU#F shown in FIG. 15, is divided into individual evacuation buffers of sizes including buffer data and BIT and buffer set information. This is shown in FIG. 16. Each individual evacuation buffer in the evacuation buffer 118 is recorded as data to be copied for one generation, i.e., buffer set information, a BIT, and buffer data, are stored in generation order.

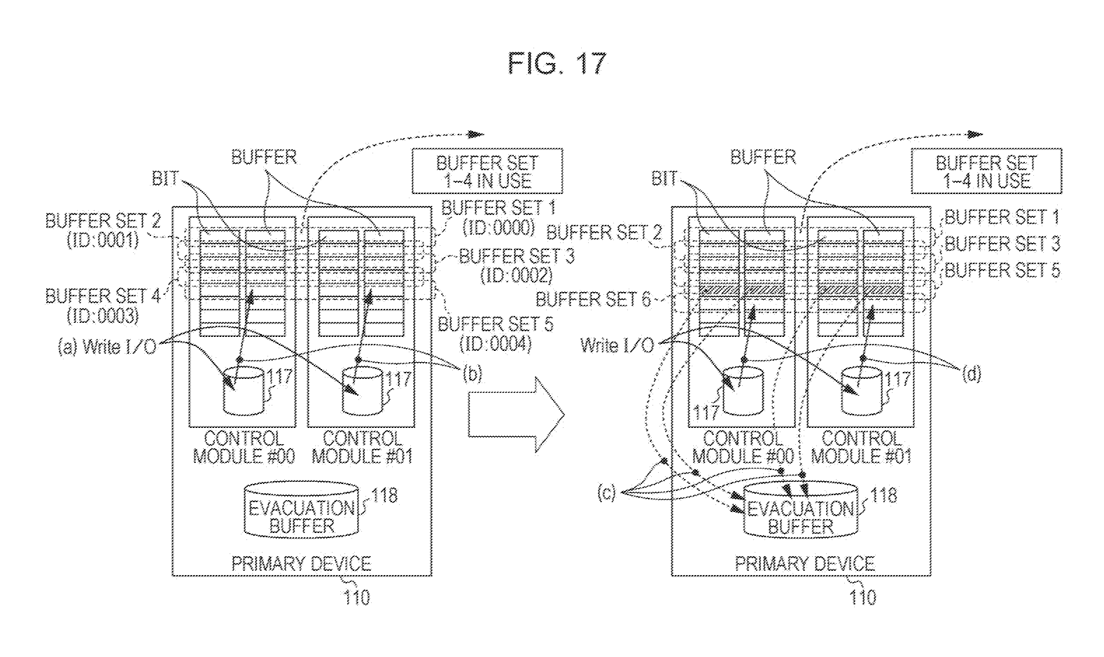

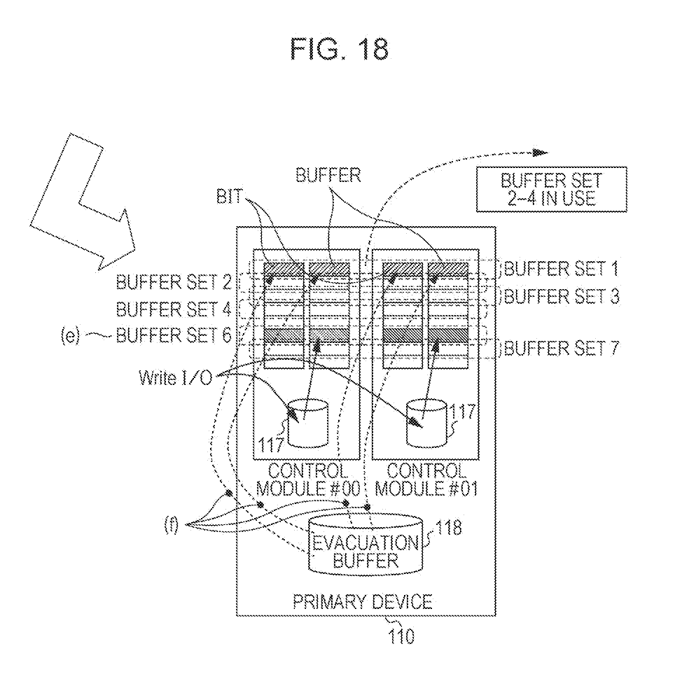

FIGS. 17 and 18 are drawings for describing buffer evacuation processing according to the present embodiment.

Note that FIGS. 17 and 18 illustrate the operations of the primary device 110 in the event of performing remote copying from the primary device 110 to the secondary device 120. In the event of performing remote copying from the secondary device 120 to the primary device 110, the same operations as those shown in FIGS. 17 and 18 can be performed as well.

Also, FIGS. 17 and 18 illustrate the configuration of the primary device 110 in a simplified manner to facilitate understanding. For example, only the control modules #00 and 01 are shown, but this does not imply that the primary device 110 is needed to be restricted to the configurations shown in FIGS. 17 and 18. Also, a disk device 117 is shown for each control module to facilitate description, but this does not imply that the primary device 110 is needed to be restricted to the configurations shown in FIGS. 17 and 18.

FIG. 17 illustrate buffer evacuation processing in a case in which a buffer set 1-4 receives a write I/O command in a state of being is in use from transferring or standing by for rendering processing at the secondary device 120. In the following, we say that the buffer set data stored in the buffer set 1-4 is each generation 1, generation 2, generation 3, and generation 4. Also, we collectively refer to all control modules of the primary device 110 as “control module”.

(a) Upon receiving a write I/O command, the control module stores the write data in its own disk device 117, and (b) stores copy data of the write data in a buffer set 5. The buffer set data stored in the buffer set 5 is generation 5.

Now, in the event that the number of buffer sets in use exceeds the buffer threshold, for example, (c) the control module evacuates the buffer data regarding which transfer to the secondary device 120 is planned next, e.g., the generation 5 buffer data stored in the buffer set 5, to the evacuation buffer 118.

Also, upon evacuating the buffer set data to the evacuation buffer, the control module switches the storage destination of new write data or the like from the buffer set 5 to the buffer set 6.

(d) Upon receiving a new write I/O command, the control module stores the write data in the disk device, and also stores copy data of the write data in the buffer set 6. The buffer set data stored in the buffer set 6 is generation 6.

At this time, generations older than the generation 6 in the buffer set, e.g., generation 5 in FIG. 17, have been evacuated to the evacuation buffer 118, so (e) the control module evacuates the buffer set data of buffer set 6 to the evacuation buffer 118.

Upon the buffer set 1 which had been in use being released, (f) the control module reads out the buffer set data of generation 5 that had been stored in the evacuation buffer 118, and stores in the buffer set 1. No that in the present embodiment, the term “release” module to put a buffer set into an unused state.

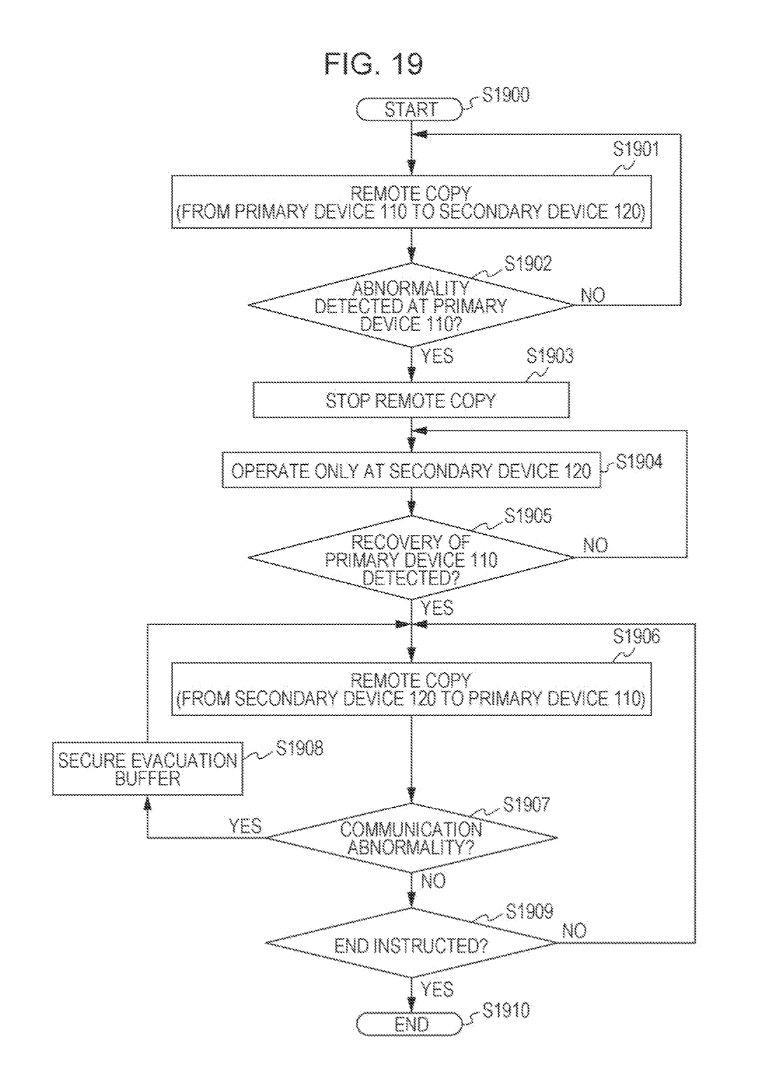

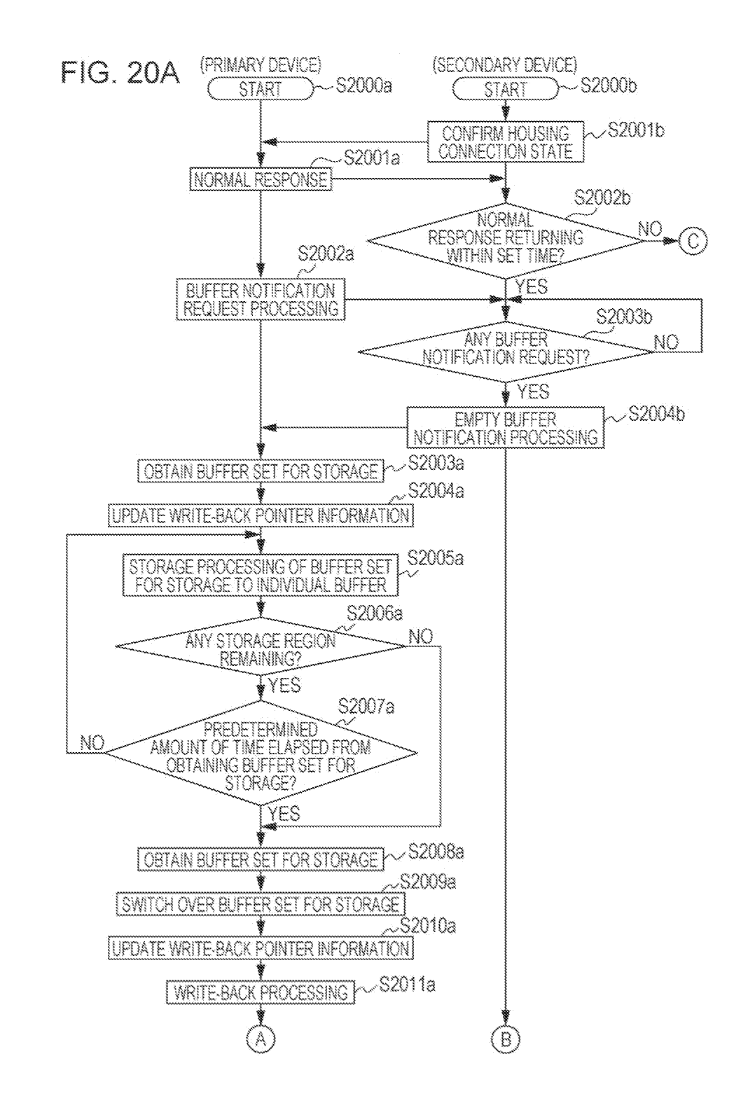

FIG. 19 is a flowchart illustrating the overview of processing at the storage system 100 according to the present embodiment.

In step S1901, upon receiving a write I/O from the host 150, the primary device 110 writes the write data to the disk device 117. At the same time, the primary device 110 transmits the write data to the secondary device 120, and performs remote copying. At this time, the secondary device 120 is monitoring whether or not there is any abnormality at the primary device 110.

Hereinafter, remote copying from the primary device 110 to the secondary device 120 is referred to as “forward” remote copying.

In the event that there is no abnormality at the primary device 110 (No in step S1902), forward remote copying from the primary device 110 to the secondary device 120 continues. In the event that an abnormality has been detected at the primary device 110 (Yes in step S1902), the secondary device 120 stops the remote copying (step S1903). At this time, the primary device 110 undergoes maintenance work for recovery.

In step S1904, the secondary device 120 proceeds with operation on its own. For example, in the event of receiving a write I/O command, the secondary device 120 writes the write data to the disk device 127.

The secondary device 120 continues operation on its own (No in step S1905) until recovery of the primary device 110 is detected. Upon detecting that the primary device 110 has recovered (Yes in step S1905), the secondary device 120 starts remote copying from the secondary device 120 to the primary device 110 (step S1906).

Hereinafter, remote copying from the secondary device 120 to the primary device 110 is referred to as “back” remote copying.

Upon detecting a communication abnormality in the communication with the primary device 110 (Yes in step S1907), the secondary device 120 secures the evacuation buffer 130 in the disk device 127 (step S1908). Subsequently, the secondary device 120 transitions the processing to step S1906, and continues the remote copying to the primary device 110. However, in the event that the evacuation buffer 130 has already been secured, the processing of step S1908 may be skipped.

If no abnormality in the communication with the primary device 110 is detected (No in step S1907), the secondary device 120 confirms whether or not there is an end instruction from the user (step S1909). In the event that there is no end instruction from the user (No in step S1909), the secondary device 120 continues remote copying to the primary device 110 (step S1906). In the event that there is an end instruction from the user (Yes in step S1909), the primary device 110 and secondary device 120 end remote copying (step S1910).

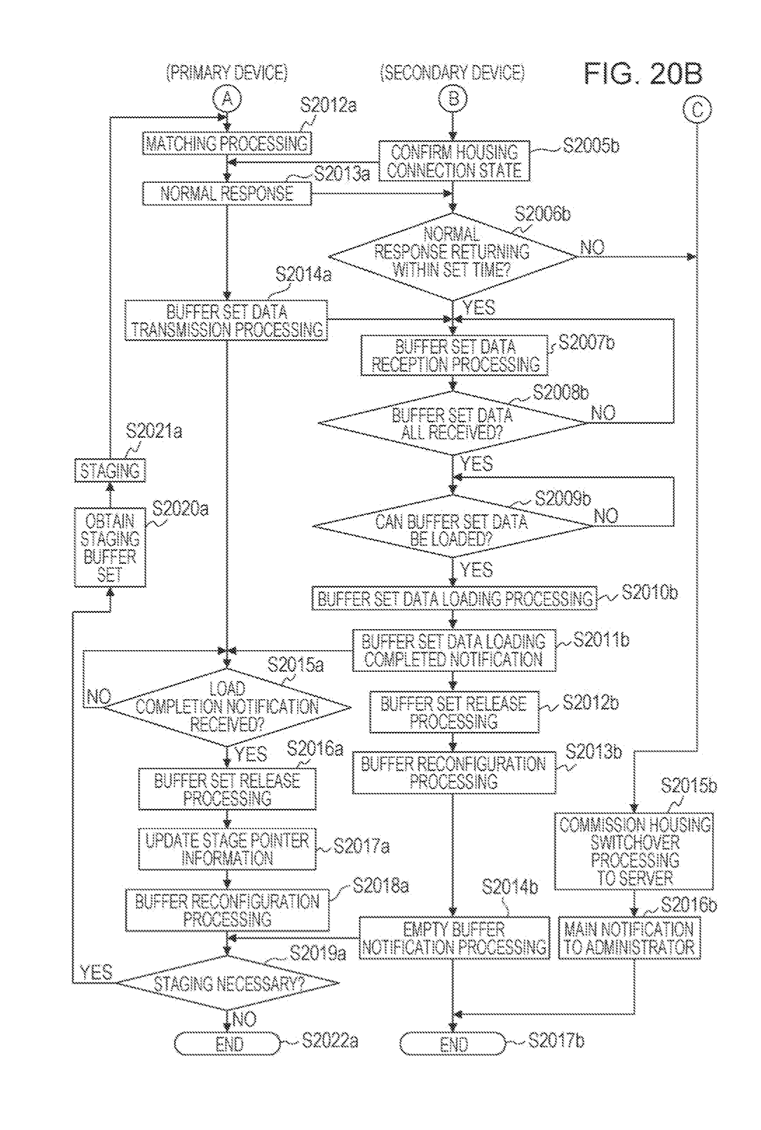

FIGS. 20A and 20B are flowcharts illustrating the overview of forward remote copying according to the present embodiment (step S1901 through step S1902). The overview of forward remote copying according to the present embodiment is described with reference to FIGS. 20A and 20B.

Upon being activated, the primary device 110 performs buffer initialization processing. For example, the primary device 110 secures a region of the configuration shown in FIG. 2 in memory 200 which each control module has, following configuration information set beforehand, and performs initialization for each region.

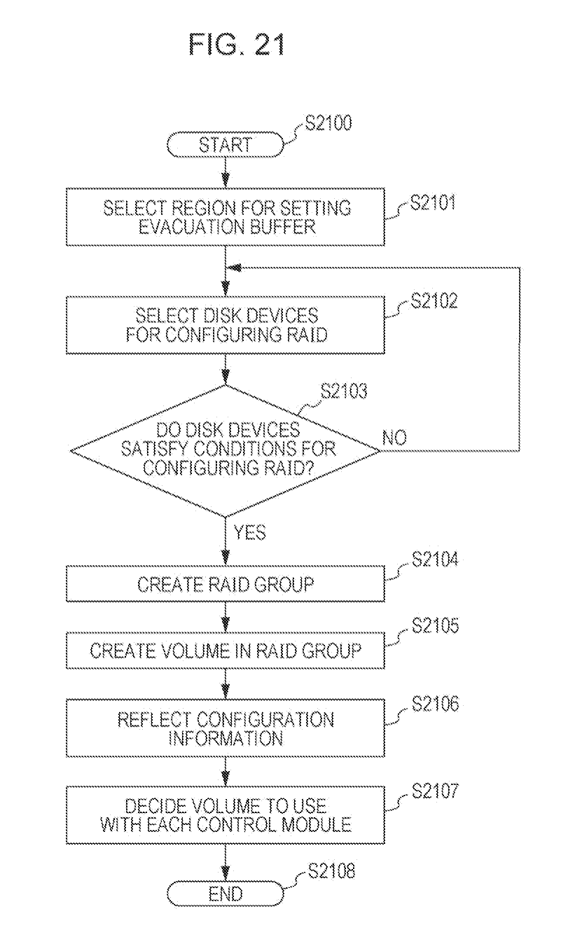

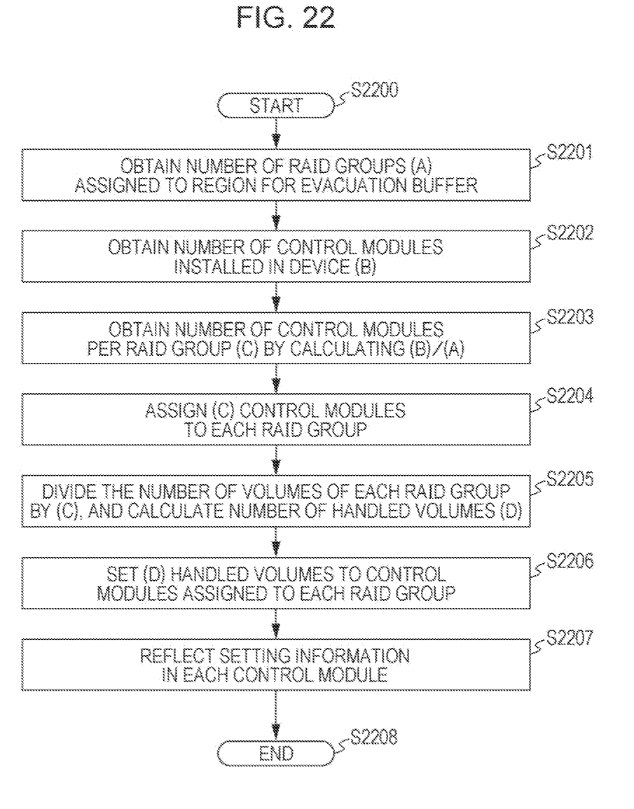

Also, the primary device 110 appropriates volume groups as to recording dedicated buffers, for each control module. Specific processing is described with reference to FIGS. 21 and 22.

Also, the primary device 110 generates a buffer set, and performs initial creating processing for the generated buffer set. For example, the primary device 110 combines individual buffers of the control models to generate a buffer set. The primary device 110 then stores the generated buffer set in the buffer set information storage unit 202 as buffer set information.

The above-described processing is also performed by the secondary device 120.

The primary device 110 further performs initialization regarding the buffer management table 300, buffer set management table 400, evacuation buffer management table 500, and so forth.

As a result of the above processing, preparation for performing remote copying between the primary device 110 and the secondary device 120 is completed. Upon receiving a write I/O command from the host 150, the remote copying is started (steps S2000a, S2000b).

In step S2001b, the secondary device 120 performs confirmation of the housing connection state as to the primary device 110. For example, the secondary device 120 makes a response request for housing connection state connection to the primary device 110.

On the other hand, in step S2001a, upon receiving a response request from the secondary device 120, the primary device 110 makes a response to the secondary device 120 to the effect that the housing connection state is normal.

In step S2002b, the secondary device 120 monitors whether or not a normal response is returned from the primary device 110 within a set amount of time. Upon confirming that a normal response has been returned from the primary device 110 within the set amount of time (Yes in step S2002b), the secondary device 120 transitions the flow to step S2003b. Also, in the event that a normal response has not been returned from the primary device 110 within the set amount of time (No in step S2002b), the secondary device 120 transitions the flow to step S2015b.

While the processing of steps S2001a, S2001b through S2002b, and S2015b through S2016b has been illustrated in the flowchart in FIG. 20A to facilitate understanding, this may be performed independently from the processing shown in the flowchart. The following processing of steps S2013a, S2005b through S2006b, and S2015b through S2016b may also be performed independently from the processing shown in the flowchart.

In step S2002a, the primary device 110 issues an unused buffer notification request command to the secondary device 120, to request notification of unused individual buffers.

On the other hand, the secondary device 120 transitions the processing to step S2003b, and monitors for an unused buffer notification request command (No in S2003b), until an unused buffer notification request command is received from the primary device 110.

Upon receiving an unused buffer notification request command from the primary device 110 in step S2003b (Yes in S2003b), the secondary device 120 transitions the processing to step S2004b.

In step S2004b, the secondary device 120 searches of an individual buffer that has already had its region released and is unused. Upon detecting an individual buffer that has already had its region released and is unused, the secondary device 120 notifies the buffer ID of the detected individual buffer to the primary device 110 as an unused buffer ID.

On the other hand, upon receiving notification of an unused buffer ID from the secondary device 120, the primary device 110 stores the notified unused buffer ID in the unused buffer ID storage unit 206.

In step S2003a, the primary device 110 obtains the buffer set to which the write data is to be stored. This buffer set to which the write data is to be stored is referred to as “storing object buffer set”.

For example, the primary device 110 makes reference to the buffer set management table 400 and obtains a buffer set ID set to unused. The primary device 110 then sets the obtained buffer set ID to the object buffer set ID in the buffer management table 300.

The primary device 110 performs the following processing with the buffer set which the buffer set ID has been set to the object buffer set ID in the buffer management table 300, as the “storing object buffer set”.

Note that the primary device 110 does not perform matching processing at step S2003a. The primary device 110 performs matching processing in the later-described step S2012a, i.e., before transmission of the buffer set data.

In step S2004a, the primary device 110 updates the generation set to the write-back pointer information in the buffer management table 300 to a value incremented by 1.

In step S2005a, the primary device 110 performs storage processing of the write data to the individual buffer of the storing object buffer set.

For example, let us say that the primary device 110 accepts a write I/O command from the host 150. The primary device 110 then stores the write data received along with the write I/O command in the storing object buffer set which the object buffer set ID currently used by the buffer management table 300 indicates, i.e., in the individual buffers of the control module in a distributed manner.

In step S2006a, the primary device 110 determines whether or not the storage region is remaining for storing data in the storing object buffer set. In the event that determination is made that there is no storage region remaining in the storing object buffer set (No in step S2006a), the primary device 110 transitions the processing to step S2008a.

Also, in the event that determination is made that there is storage region remaining in the storing object buffer set (Yes in step S2006a), the primary device 110 transitions the processing to step 2007a. In this case, the primary device 110 determines whether or not a certain amount of time has elapsed from obtaining the storing object buffer set (step S2007a).

In the event that determination is made that a certain amount of time has not elapsed from obtaining the storing object buffer set (No in step S2007a), the primary device 110 transitions the processing to step S2005a. Also, in the event that determination is made that a certain amount of time has elapsed from obtaining the storing object buffer set (Yes in step S2007a), the primary device 110 transitions the processing to step S2008a.

In step S2008, the primary device 110 newly obtains a storing object buffer set in the same was as with the processing in step S2003a. In step S2009a, the primary device 110 switches the storing object buffer set with the new storing object buffer set obtained in step S2008a.

In the following, a storing object buffer set before switchover is referred to as “write-back object buffer set” in the processing in step S2011a, and “transfer object buffer set” in the processing of step S2014a and subsequent steps.

In step S2010a, the primary device 110 updates the write-back pointer information in the same way as with the processing in step S2004a. In step S2011a, the primary device 110 then performs write-back. Subsequently, the primary device 110 transitions the processing to step S2012a.

In step S2012a, the primary device 110 performs matching processing. For example, the primary device 110 obtains an unused buffer ID from the unused buffer ID storage unit 206. The primary device 110 then appropriates the obtained unused buffer ID to the copy destination ID of the transfer object buffer set, so as to correlate the copy source ID and copy destination ID of the transfer object buffer set.

On the other hand, in step S2005b, the secondary device 120 makes a response request for housing connection state confirmation to the primary device 110, to perform confirmation of the housing connection state as to the primary device 110.

In step S2013a, upon receiving the response request from the secondary device 120, the primary device 110 makes a response to the secondary device 120 to the effect of the housing connection state being normal.

In step S2006b, the secondary device 120 monitors whether or not a normal response is returned from the primary device 110 within a set amount of time. Upon confirming that a normal response has been returned from the primary device 110 within the set amount of time (Yes in step S2006b), the secondary device 120 transitions the flow to step S2007b. Also, in the event that a normal response has not been returned from the primary device 110 within the set amount of time (No in step S2006b), the secondary device 120 transitions the flow to step S2015b.

In step S2014a, the primary device 110 transmits buffer set data stored in the transfer object buffer set to the secondary device 120. This buffer set data includes, for each control mode, buffer data stored in the buffer 201a, a BIT stored in the BIT storage unit 201b, and buffer set information stored in the buffer set information storage unit 202.

On the other hand, in step S2007b, the secondary device 120 performs reception processing for the buffer set data. For example, of the received buffer set data, the secondary device 120 stores the buffer data in the buffer 201a, the BIT in the BIT storage unit 201b, and the buffer set information in the buffer set information storage unit 202, respectively.

In step S2008b, the secondary device 120 determines whether or not all buffer set data has been received. In the event that determination is made that not all buffer set data has been received (No in S2008b), the secondary device 120 transitions the processing to step S2007b, and repeats the processing of steps S2007b through S2008b.

In step S2008b, in the event that determination is made that all buffer set data has been received (Yes in S2008b), the secondary device 120 transitions the processing to step S2009b.

In step S2009b, the secondary device 120 determines whether or not the buffer set data obtained in step S2007b can be loaded to the disk device 127 of its own storage device. In the event that determination is made that the obtained the buffer set data can be loaded (Yes in S2009b), the secondary device 120 transitions the processing to step S2010b.

In step S2010b, the secondary device 120 loads the buffer set data obtained in step S2007b to the disk device 127 of its own storage device. Upon this loading ending, the secondary device 120 transitions the processing to step S2011b, and makes notification to the primary device 110 to the effect that loading of the buffer set data has been completed. Hereinafter, this notification is referred to as “buffer set data load completion notification”.

Upon loading of the buffer set data to the disk device 127 ending, in step S2012b, the secondary device 120 performs buffer set releasing processing. For example, the secondary device 120 sets the buffer set regarding which loading of the buffer set data to the disk device 127 has been completed to unused.

In step S2013b, the secondary device 120 secures a region for the buffer set information storage unit 202 and recording dedicated buffer 201 in the released region, and configures the configuration shown in FIG. 2, for example.

Upon the above processing ending, the secondary device 120 transitions the flow to step S2014b, and makes notification to the primary device 110 of the unused buffer ID of the buffer than has become newly usable in accordance with the processing in steps S2012b through S2013b. Upon being notified of the unused buffer ID, the primary device 110 stores the notified unused buffer ID in the unused buffer ID storage unit 206.

On the other hand, in step S2015a, the primary device 110 determines whether or not a buffer set data load completion notification has been received from the secondary device 120. In the event that determination is made that no buffer set data load completion notification has been received (No in S2015a), the processing of step S2015a is repeated. Also, upon receiving a buffer set data load completion notification from the secondary device 120 (Yes in S2015a), the primary device 110 advances the processing to step S2016a.

In step S2016a, the primary device 110 performs buffer set releasing processing, in the same way as in step S2012b, for the transfer object buffer set regarding which the buffer set data transfer processing has been performed in step S2014a. That is to say, the primary device 110 makes reference to the buffer set management table 400, and sets the transfer object buffer set regarding which transfer of data has been completed to unused.

In step S2017a, the primary device 110 makes reference to the buffer management table 300, and updates the generation set to the stage pointer information to a value incremented by 1. In step S2018a, the primary device 110 performs buffer reconfiguration such as initializing the buffer set region that is no more used.

In step S2019a, the primary device 110 determines whether or not staging is needed. For example, the primary device 110 determines whether or not staging is needed, depending on whether or not there is a generation evacuated to the evacuation buffer 118.

The primary device 110 can tell whether or not there is a generation evacuated to the evacuation buffer 118, by the processing in the following (a) through (d).

(a) The primary device 110 makes reference to the buffer management table 300 and obtains write-back pointer information and stage pointer information.

(b) The primary device 110 makes reference to the buffer set management table 400, tracks the generations in ascending order from the generation No. of the stage pointer information plus 1, and searches for a missing generation in the buffer set management table 400.

For example, generation 2 is set as the stage pointer information in the buffer management table 300 shown in FIG. 3. Accordingly, the primary device 110 makes reference to the buffer set management table 400 shown in FIG. 4, and tracks the generations in ascending order from generation 3 which is generation 2 plus 1, and then 4, 5, and so on. The primary device 110 then detects a generation 7 which is missing from the buffer set management table 400.

(c) The primary device 110 makes reference to the buffer set management table 400 and tracks back the write-back pointer information in descending order of generation No., so as to search for generations missing from the buffer set management table 400.

For example, generation 15 is set in the buffer management table 300 shown in FIG. 3 as write-back pointer information. Accordingly, the primary device 110 makes reference to the buffer set management table 400 shown in FIG. 4, and tracks the generations back in descending order from generation 15, generation 14, 13, and so on. The primary device 110 then detects a generation 12 missing from the buffer set management table 400.

(d) We can tell that the generations 7 through 12, detected by the above processing, are the generations which were evacuated to the evacuation buffer 118.

In step S2019a, in the event that determination is made that there is a generation evacuated to the evacuation buffer 118 (Yes in step S219), the primary device 110 transitions the processing to step S2020a. On the other hand, in the event that determination is made that there is no generation evacuated to the evacuation buffer 118 (No in step S219), the primary device 110 transitions the processing to step S2022a.

In step S2020a, the primary device 110 obtains a buffer set to be used for staging, i.e., a staging buffer set.

For example, the primary device 110 makes reference to the buffer set management table 400, and obtains a buffer set ID set to unused as a “staging object buffer set ID”.

Also, the primary device 110 makes reference to the buffer set management table 400 and sets a later-described staging object generation to the object generation of the buffer set ID matching the staging object buffer set ID.

Also, the primary device 110 makes reference to the buffer set management table 400 and sets the purpose of the buffer set ID matching the staging object buffer set ID to “staging”.

In step S2021a, the primary device 110 executes staging. Upon staging being completed, the primary device 110 transitions the processing to step S2012a.

Upon the above processing ending, the primary device 110 ends remote copying, or transitions the processing to step S2005a and continues remote copying. Also, in the event of accepting a new write I/O command from the host 150, the primary device 110 transitions the processing to step S2005a or the like, and continues remote copying.

Also, upon the above processing ending, the secondary device 120 ends remote copying, or transitions the processing to step S2007b and continues the remote copying.

Forward remote copying (steps S1901 through S1902) according to the present embodiment has been described so far. With back remote copying according to the present embodiment, the processing of the primary device 110 in FIGS. 20A and 20B are executed by the secondary device 120, and the processing of the secondary device 120 in FIGS. 20A and 20B by the primary device 110.

Remote copying according to the present embodiment is described in detail below. FIG. 21 is a flowchart illustrating processing for generating the region for the evacuation buffer 118 according to the present embodiment. The processing in FIG. 21 is executed at the time of maintenance work on the primary device 110, for example.

In step S2101, the primary device 110 selects a region to which an evacuation buffer 118 is set, from the buffer 201a of the recording dedicated buffer 201, in accordance with input from the user. The primary device 110 then transitions the processing to step S2102, and selects a disk device for configuring a RAID, in accordance with input from the user.

In step S2103, the primary device 110 checks whether or not the disk device selected in step S2102 satisfies conditions for configuring a RAID. In the event that the conditions are not satisfied (No in S2103), the primary device 110 makes a display on a display device or the like to the effect that another disk device is specified, and transitions the processing to step S2102.

In step S2103, in the event that the conditions are satisfied (Yes in S2103), the primary device 110 transitions the processing to step S2104.

In step S2104, the primary device 110 generates a RAID group configured of the disk device selected in step S2102, and reflects this information in configuration information holding the device configuration of the primary device 110 and so forth.

In step S2105, the primary device 110 creates multiple volumes within the RAID group created in step S2104. The primary device 110 transitions the processing to step S2106, and reflects the configuration of the logical unit created in step S2105 in the configuration information.

In step S2107, the primary device 110 determines volumes to be used by each of the control modules by processing illustrated in FIG. 22. Hereinafter, volumes to be used at each module are referred to as “handled volumes” as needed. The control modules use the determined volumes as the region for the evacuation buffer 118.

Upon the above processing ending, the primary device 110 transitions the processing to step S2108 and ends the processing for generating the region for the evacuation buffer 118.

FIG. 22 is a flowchart illustrating specific processing of appropriating the evacuation buffer 118 according to the present embodiment to the control module (step S2107). The processing shown in FIG. 22 can be executed when performing maintenance work, in addition to when the primary device 110 starts up.

In step S2201, the primary device 110 makes reference to the configuration information, and obtains the number of RAID groups (A) to be appropriated to the evacuation buffer 118.

Further, the primary device 110 transitions the processing to step S2202, and obtains from the configuration information the number of control modules (B) mounted to the primary device 110.

In step S2203, the primary device 110 calculates (C) which is the number of control modules per RAID group by calculating (C)=(B)/(A). The primary device 110 then transitions the processing to step S2204, and appropriates (C) control modules to each RAID group.

In step S2205, the primary device 110 divides the number of volumes of each RAID group by (C), and calculates the number of handled volumes (D). Then primary device 110 then transitions the processing to step S2206, and appropriates(D) handled volumes to the control modules appropriated to each RAID group, from the calculation results of step S2205.

In step S2207, the primary device 110 reflects the configuration determined by the above processing in the configuration information, and also reflects this in the setting information which each control module has, and ends the processing (step S2208).

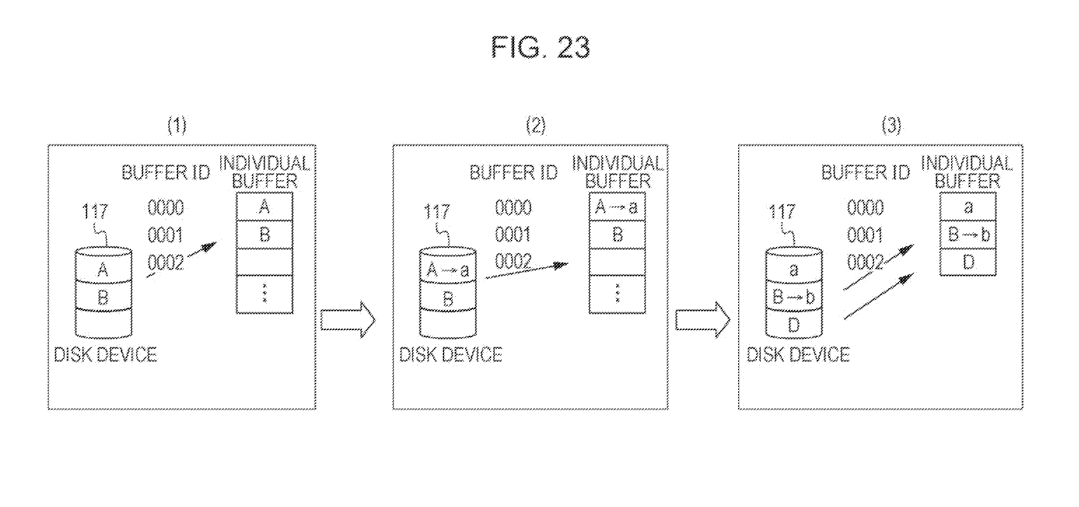

FIG. 23 is a diagram illustrating the overview of storage processing to individual buffers (step S2005a) according to the present embodiment.

Note that FIG. 23 is a diagram which has been simplified to illustrate only the relation the disk device 117 and individual buffers at the primary device 110 at the time of forward remote copying to facilitate understanding, and this illustration is not intended to be interpreted restrictively regarding the configuration of the storage system 100 according to the present embodiment, such as with regard to the disk device 117 and individual buffers, and so forth. Also, it is needless to say that in the case of back remote copying, the storage processing to individual buffers shown in FIG. 23 can be performed at the secondary device 120 as well.

For example, we say that the primary device 110 has accepted a write I/O command from the host 150. The primary device 110 then stores the white data received along with the accepted write I/O command to the storage object buffer set indicated by the object buffer set ID currently being used, that is recorded in the buffer management table 300, i.e., in the individual buffers of the control modules in a distributed manner.

Now, let us consider a case wherein write I/O commands are consecutively received from the host 150, and write data is written to the disk device 117 in the order of data A, B, a, C, b. We say that data A and a are data with the same write address specified thereto. We also say that data B and b are data with the same write address specified thereto. Further, the head address of a storage region where write data is to be stored following the request of the write I/O command is referred to as a “write address”.

(1) Upon accepting a write I/O command from the host 150, the primary device 110 makes reference to the BIT and so forth to confirm whether data of the same write address as the write data received along with the accepted write I/O command is already stored in an individual buffer.

In the event that data of the same write address as the write data is not stored in an individual buffer, the write data is stored in the individual buffer of the storing object buffer set which the currently-used object buffer set ID in the buffer management table 300 indicates. In the example in FIG. 23, an example of write data A and B being stored in individual buffers with respective buffer IDs of “0000” and “0001” in order is illustrated. Note that while FIG. 23 illustrates a case of just one data being stored per individual buffer, but this is not to be interpreted restrictively.

(2) Upon accepting a write I/O command regarding the write data a from the host 150, the primary device 110 updates the write data A to the write data a, since the data A of the same write address as the write data a is stored in the individual buffer. Note that the data size of the write data a is greater than the data size of the write data A, and accordingly cases can be conceived wherein the individual buffer which had been storing the write data A cannot store the write data a. In this case, the primary device 110 may store the write data a in a different buffer instead of updating the write data A with the write data a.

(3) Upon accepting a write I/O command regarding the write data C from the host 150, the primary device 110 stores the write data C at buffer ID “0002” since data of the same write address as the write data C is not stored in any individual buffer.

Upon accepting a write I/O command regarding the write data b from the host 150, the primary device 110 updates the write data B to the write data b, since the data B of the same write address as the write data b is stored in the individual buffer.

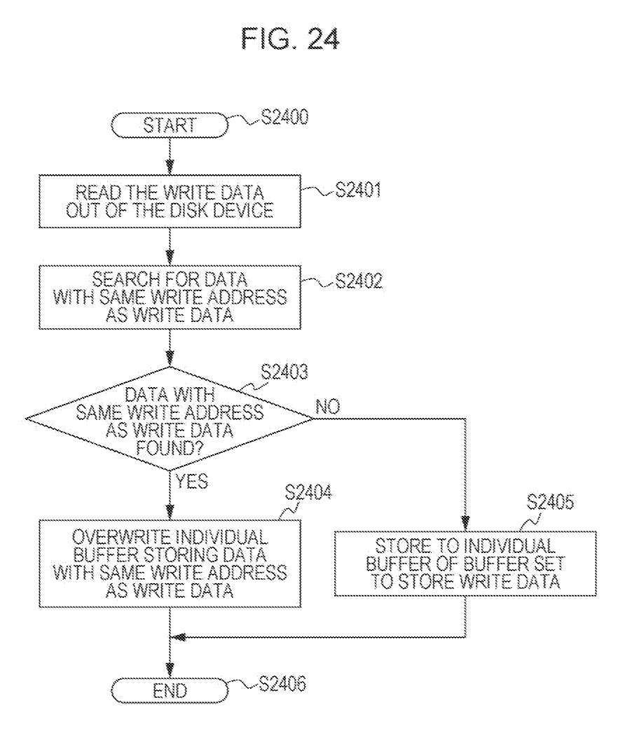

FIG. 24 is a flowchart illustrating storage processing to individual buffers (step S2005a) according to the present embodiment.

In step S2401, the primary device 110 reads out, of the write data stored in the disk device 117, data to be transferred to the secondary device 120, from the disk device 117.

In step S2402, the primary device 110 makes reference to the recording dedicated buffer 201, and searches for data of the same write address as the write data.

Upon detecting data of the same write address as the write data (Yes in step S2403), the primary device 110 overwrites the individual buffer where the detected data is stored, with the write data (step S2404).

In the event of not detecting data of the same write address as the write data (No in step S2403), the primary device 110 stores the write data to an individual buffer of the storing object buffer set (step S2405).

Upon the above processing ending, the primary device 110 ends storage processing to individual buffers (step S2406).

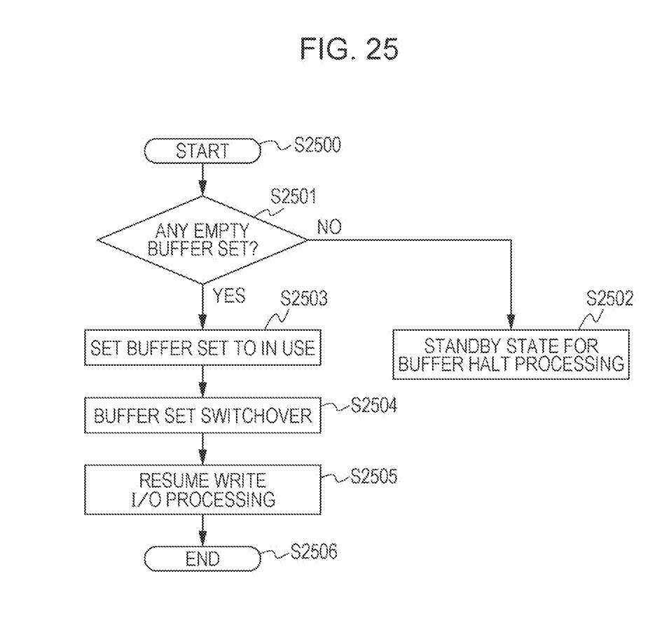

FIG. 25 is a flowchart illustrating switching processing of buffer sets according to the present embodiment. The processing in FIG. 25 illustrates specific processing of step S2009a in FIG. 20A.

For example, in the event that there is no more empty space within a buffer set because of storage processing performed in write I/O extension, or a certain amount of time elapsing after buffer set switchover processing being performed, the primary device 110, the primary device 110 starts buffer set switchover processing (step S2500).

In step S2501, the primary device 110 determines whether or not there is an empty buffer set, i.e., a buffer set which is set as unused in the buffer set management table 400.

In step S2501, in the event that there is no empty buffer set (No in step S2501), the primary device 110 transitions the processing to step S2502, and goes to a buffer halt processing standby state (step S2502). Subsequently, upon the buffer halt processing being executed and the buffer depletion state being resolved, the primary device 110 resumes the processing of the write I/O command. In the buffer halt processing, part or all of data stored in the storage unit shown in FIG. 2, such as the recording dedicated buffer, buffer set information storage unit, and so on, can be cleared.

In this case, the primary device 110 writes back to dedicated bitmap the information such as write data stored in the buffer set, e.g., write data and the BIT thereof and so on, and after executing the buffer halt processing, performs remote copy transfer following the bitmap, without guarantee of order.

In step S2501, in the event that there are empty buffer sets (Yes in step S2501), the primary device 110 transitions the processing to step S2503. The primary device 110 then selects one empty buffer set, and sets the selected buffer set to the used status, i.e., sets staging, write-back, or recording, to the purpose space of the buffer set management table 400 as needed (step S2503).

In step S2504, the primary device 110 switches the buffer set to be used to the buffer set selected in step S2503. The primary device 110 then makes reference to the standby queue managing write I/O commands, and resumes processing on the standby write I/O (step S2505).

Upon the above processing ending, the primary device 110 ends the processing for switching buffer sets (step S2506).

With the buffer evacuation processing according to the present embodiment, the write position (generation) of data to be stored in the evacuation buffers 118 and 130, and the read position (generation) of data to be read out from the evacuation buffers 118 and 130, are managed by the two types of information of write-back pointer information and stage pointer information.

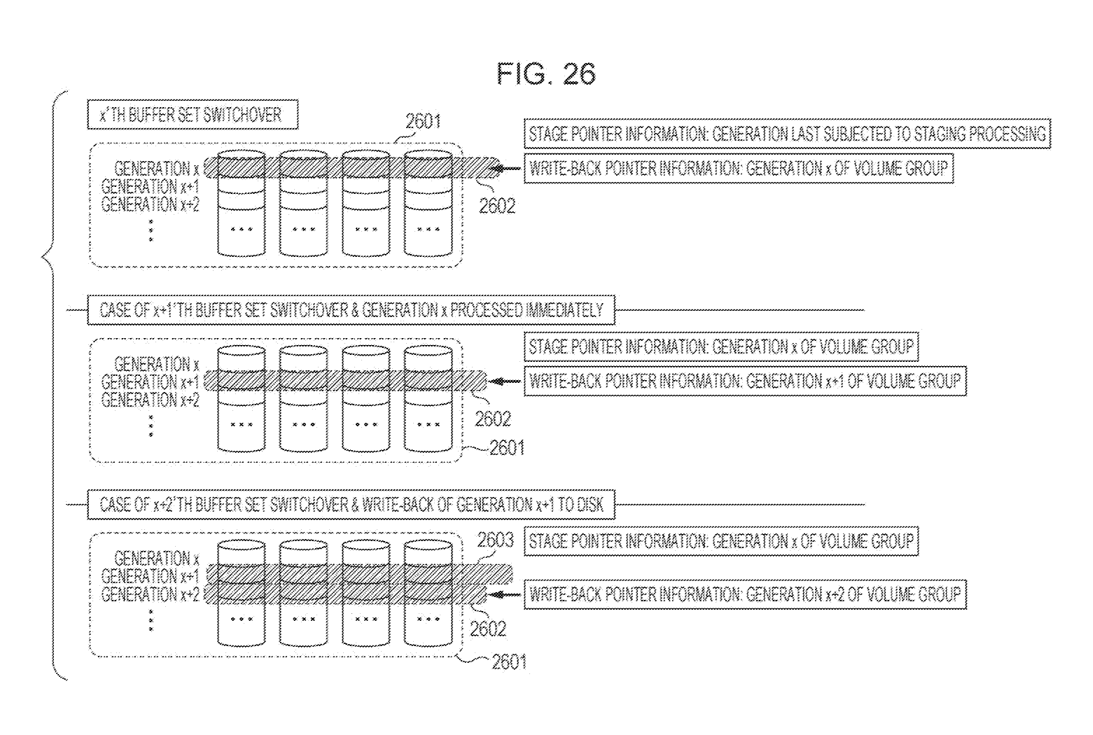

FIG. 26 is a diagram for describing the write-back pointer information and stage pointer information in the buffer evacuation processing according to the present embodiment. Reference numeral 2601 in FIG. 26 is a simplification of the evacuation buffer 118. In the same way, reference numerals 2602 and 2603 in FIG. 26 are simplifications of buffer sets.

For example, let us consider a case of buffer set switchover being performed for the x'th time at a control module. In this case, the stage pointer information holds the generation of the buffer set where staging was performed last. The write-back pointer information holds the generation x of the evacuation buffer 2601 as information.

Also, let us consider a case of buffer set data of generation x being immediately transferred to the secondary device 120 at the time of buffer set switchover being performed for the x+1'th time at a control module. In this case, the buffer set data stored in generation x is staged from the evacuation buffer 118 to the buffer set at the primary device 110. Upon the transfer processing of the buffer set data from the primary device 110 to the secondary device 120 being completed, the stage pointer information is updated from generation x to generation x+1. The write-back pointer information holds the generation x+1 of the evacuation buffer 2601 as information.

Further, let us consider a case of write-back of generation x+1 to the evacuation buffer 2601 at the time of buffer set switchover being performed for the x+2'th time at a control module. In this case, in the event that the generation of the evacuation buffer 2601 which the stage pointer information holds is generation x, the object the next staging is generation x+1. The write-back pointer information holds the generation x+2 of the volume group.

As described above, the write-back pointer information holds the next generation of the buffer set generated each time a buffer set is generated. Also, each time processing of an old generation buffer set which has been switched over is completed, e.g., each time buffer set data transfer is completed at the primary device 110 and also loading of the data at the secondary device 120 is completed, the stage pointer information is updated.

Note that in the event that there are multiple volume groups appropriated as evacuation buffers 2601, the volume groups are use in order of small Nos. appropriated to the volume groups. In the event that the volume groups are used up to the end, the first volume group is returned to, so as to use the volume groups cyclically.

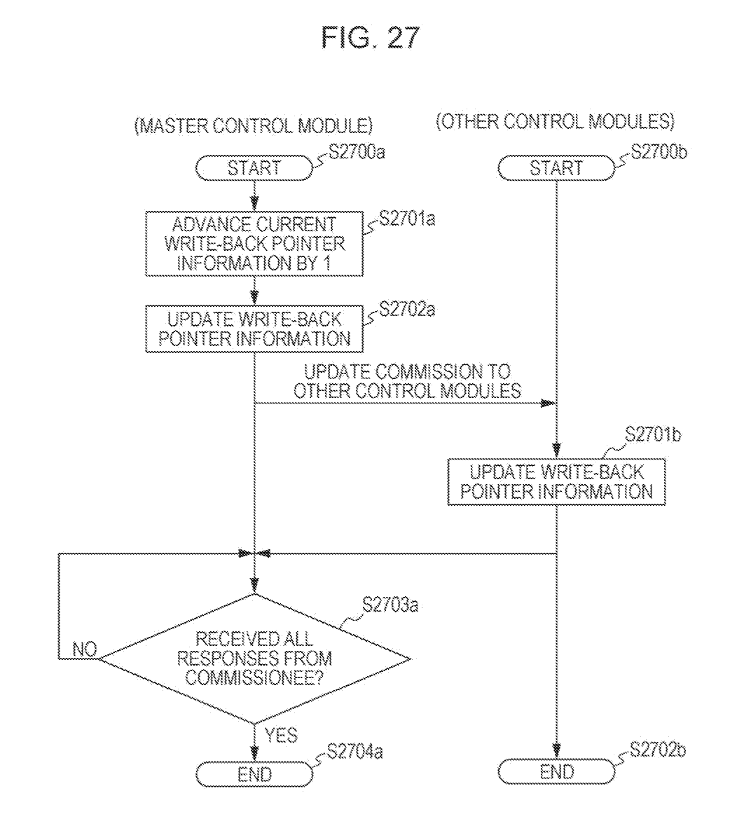

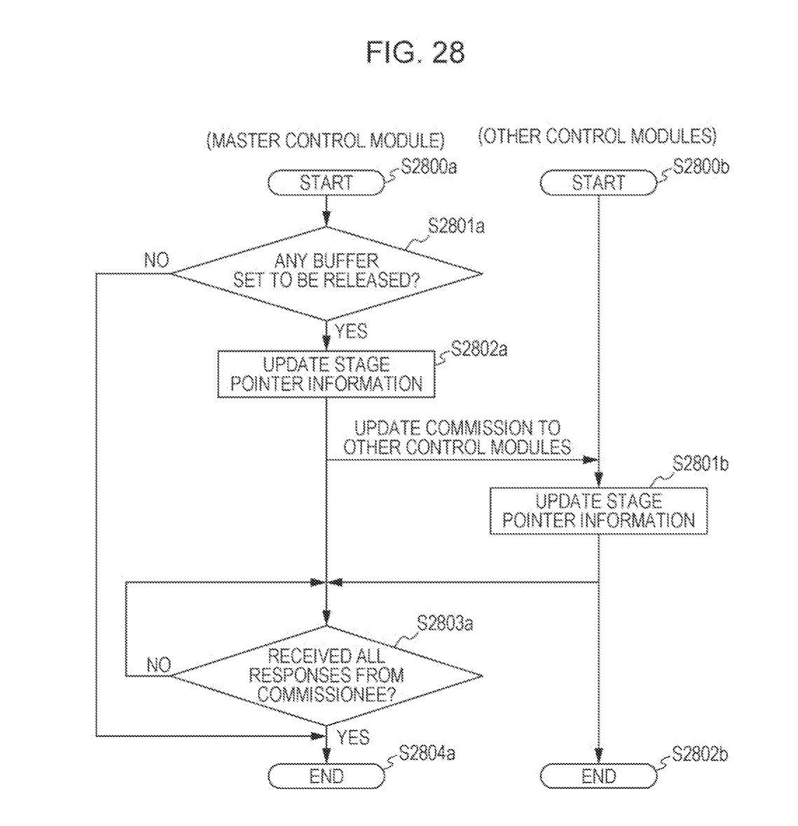

The following is a specific description of updating processing of the write-back pointer information and stage pointer information in FIGS. 27 and 28.

FIG. 27 is a flowchart illustrating the updating processing of the write-back pointer information according to the present embodiment.

In step S2700a, upon buffer set switchover processing being performed, the master control module representing the control modules of the primary device 110 transitions the processing to step S2701a.

In step S2701a, the master control module advances by 1 the write-back pointer information currently held. For example, the master control module increments the generation held in the write-back pointer information of the buffer management table 300 by 1.

In step S2702a, the master control module updates the write-back pointer information in the buffer management table 300 which it holds itself, with the write-back pointer information obtained in step S2701a. Further, the master control module commissions other control modules of the primary device 110 to perform the same processing as in step S2702a.

On the other hand, in step S2701b, the control modules update the write-back pointer information in the buffer management table 300 which each holds within itself, with the write-back pointer information obtained in step S2701a. Upon updating of the buffer management table 300 ending, the control modules then make notification to the master control module to that effect.

In step S2703a, the master control module checks whether or not a response has been received from all commissioned control modules, and in the event that there is a control module from which a response has not been received (No in step S2703a), the processing of step S2703a is repeated.

In step S2703a, in the event that determination is made that a response has been received from all commissioned control modules (Yes in S2703a), the master control module transitions the processing to step S2704a. On the other hand, after the processing of step S2701b, the secondary device 120 transitions the processing to step S2702b. The write-back pointer information updating processing thus ends.

FIG. 28 is a flowchart illustrating stage pointer information updating processing according to the present embodiment.

In step S2800a, upon starting buffer set releasing processing, the master control module of the primary device 110 transitions the processing to step S2801a.

In step S2801a, the master control module determines whether or not there is a buffer set to be released. In the event that there is no buffer set to be released (No in step S2801a), the master control module transitions the processing to step S2804a, and the processing ends.

Note that with the present embodiment, a buffer set regarding which notification has been received to the effect that transfer of buffer data to the secondary device 120 has been completed, and also that loading of the buffer set data transferred from the secondary device 120 has been completed, is judged to be an object of region releasing. This notification is sent from the master control module of the secondary device 120 to the master control module of the primary device 110, for example.

In step S2801a, in the event that there is a buffer set to be released (Yes in step S2801a), the master control module transitions the processing to step S2802a.

In step S2802a, the master control module releases the individual buffers of the buffer set which is the object of releasing, and releases the BIT and buffer set information, and also updates the stage pointer information. For example, the master control module updates the generation held in the stage pointer information of the buffer management table to the next generation.

Also, the master control module commissions other control modules of the primary device 110 to perform the same processing as in step S2802a.

In step S2801b, upon receiving the update commission from the master control module, the control modules release the individual buffers of the buffer set which is the object of releasing, and release the BIT and buffer set information, and also updates the stage pointer information. When the processing is completed, the control modules perform completion notification to the master control module.

In step S2803a, the master control module confirms the response from the control modules which have been commissioned, i.e., the completion notification, and determines whether or not a response has been received from all control modules. In the event that there is a control module from which a response has not been received (No in step S2803a), the processing of step S2803a is repeated.

In step S2803a, in the event that determination is made that a response has been received from all commissioned control modules (Yes in S2803a), the master control module transitions the processing to step S2804a. After the processing of step S2801b, the other control modules transition the processing to step S2802b. The stage pointer information updating processing thus ends.

FIG. 29 is a flowchart illustrating write-back according to the present embodiment.

In step S2009a, upon storage processing of write data to the buffer set for example, the master control module of the primary device 110 transitions the processing to step S2901a.

In step S2901a, the master control module obtains the number of buffer sets in use for staging and transfer. The master control module then compares the number of buffer sets in use for staging and transfer with the buffer threshold, and in the event that the number of buffer sets in use is not equal to or greater than the buffer threshold (No in S2901a), transitions the processing to step S2905a. Also, in the event that the number of buffer sets in use is equal to or greater than the buffer threshold (Yes in S2901a), the master control module transitions the processing to step S2902a.

In step S2902a, the master control module performs write-back as follows. Note that a buffer set to be subjected to write-back is referred to as a “write-back object generation”.

First, the master control module calculates the address of an individual evacuation buffer regarding which the write-back target generation is stored, from the evacuation buffer management table 500. The master control module then stores, to the calculated address, buffer data stored in individual buffers of the master control module out of the write-back object buffer sets described with step S2009a in FIG. 20A, the BIT thereof, and buffer set information.

Note that in the event that the evacuation buffer appropriated to the control module is a continuous address space, the head address of the individual evacuation buffer can be obtained by adding “(write-back object generation−1)×individual evacuation buffer size” to the “storing head address of evacuation data” set in the evacuation buffer management table 500.

Upon write-back being completed, the master control module commissions processing the same as in step S2902a to the other control modules of the primary device 110.

In step S2901b, the control modules obtain, from their own BIT storage unit 201b and so forth, buffer data stored in individual buffers of the control modules out of the buffer sets commissioned from the master control module, the BIT thereof, and buffer set information. The control modules evacuate the obtained BIT and buffer set information to the individual evacuation buffers appropriated to the control modules.

Note that with the individual evacuation buffers appropriated to the control modules as well, in the event that an evacuation buffer appropriated to the control module is a continuous address space, the head address thereof can be obtained by adding “(write-back object generation−1)×individual evacuation buffer size” to the “storing head address of evacuation data” set in the evacuation buffer management table 500.

In step S2902b, the control modules check whether or not buffer data such as write data or the like is stored in individual buffers of the control modules, of the buffer set commissioned by the master control module.

In the event that there is no buffer data such as write data or the like in the individual buffers (No in S2902b), the control modules skip step S2903b. Also, in the event that there is buffer data such as write data or the like in the individual buffers (Yes in S2902b), the control modules transitions the processing to step S2903b.

In step S2903b, the control modules evacuate the buffer data such as write data or the like stored in the individual buffers to the individual evacuation buffers of the evacuation buffer 118 appropriated to the control modules. The control modules then make notification of completion of the commissioned processing to the master control module.

On the other hand, in step S2903a the master control module checks whether or not a response has been received from the control modules which have been commissioned, and in the event that there is a control module from which a response has not been received (No in step S2903a), the processing of step S2903a is repeated.

In the event that responses have been received from all control modules (Yes in step S2903a), the master control module releases the buffer set information of the write-back object buffer set and so forth (step S2904a). Also, the control module makes reference to the buffer set management table 400 and sets the buffer set ID matching the buffer set ID of the write-back object buffer set to unused.

Upon the above processing ending, the master control module transitions the processing to step S2905a, and ends the buffer evacuation processing. The other control modules, after the processing of S2902b or S2903b, transition the processing to step S2904b and end the buffer evacuation processing.

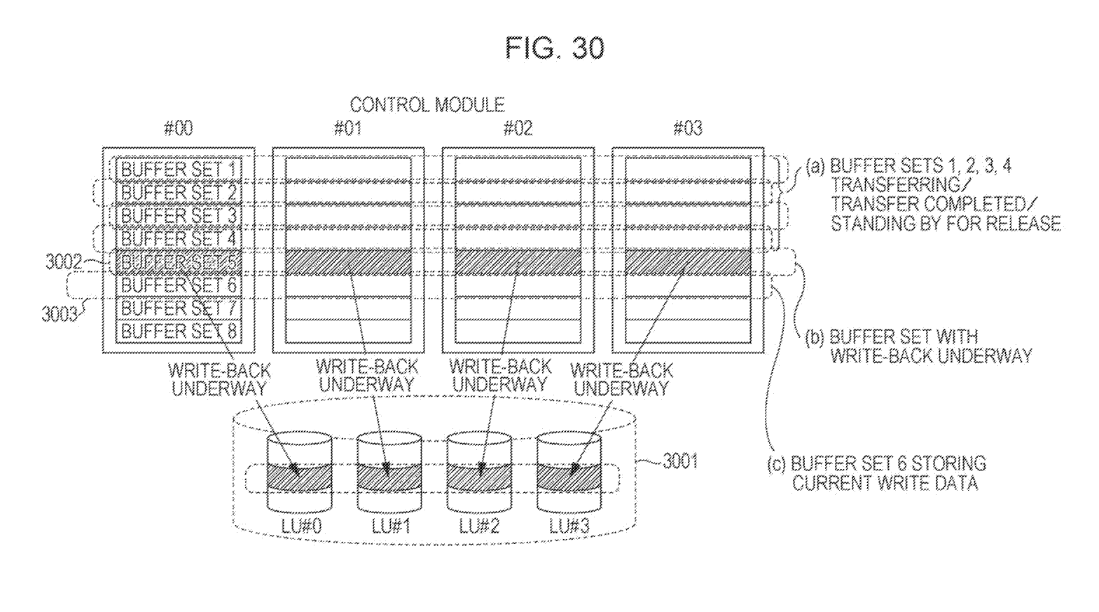

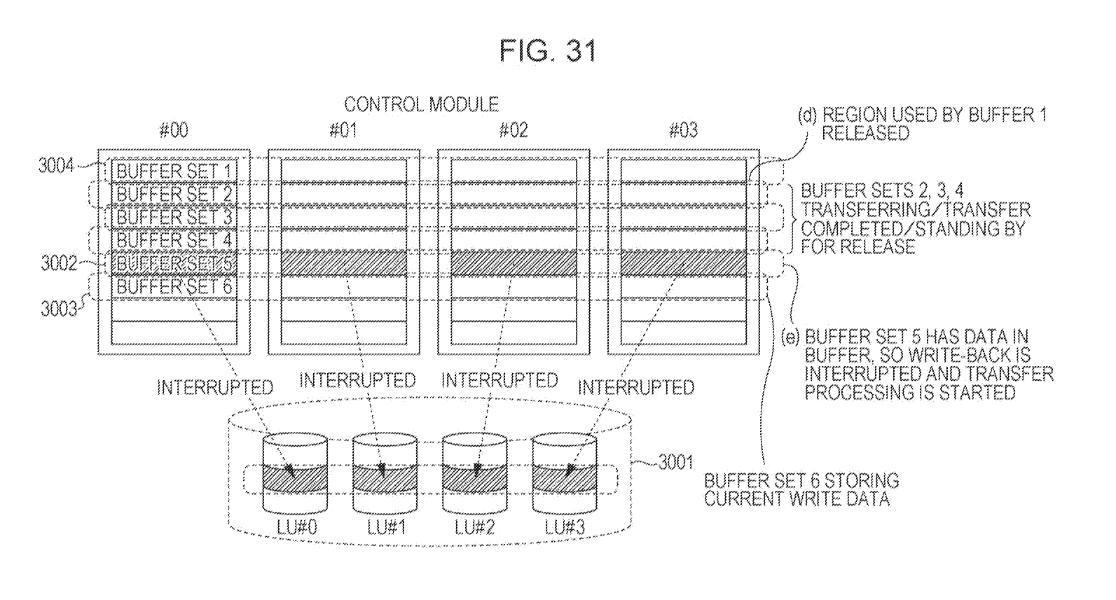

FIGS. 30 and 31 are diagrams illustrating a specific example of write-back according to the present embodiment. In FIGS. 30 and 31, reference numeral 3001 is a simplification of the evacuation buffer 118. In the same way, reference numerals 3002 through 3004 in FIGS. 30 and 31 are simplifications of buffer sets.

FIGS. 30 and 31 are diagrams for describing write-back in a case where the primary device 110 has control modules #00 through #03, each control module has eight individual buffers, and the buffer threshold is 4.

Let us consider a state wherein (a) buffer sets 1 through 4 are in a state of either transfer, transfer standby, or release standby, and (b) buffer set 5 is undergoing write-back. In this case, (c) it is the buffer set 6 that stores the write data.

As shown in FIG. 31, (d) when the region used by the buffer set 1 is released, the master control module updates the stage pointer information.

In the event that the write-back of the buffer set 5 is undergoing processing, (e) the data is on the recording dedicated buffer 201 and so forth, so the write-back of the buffer set 5 is interrupted, and processing for transferring the buffer set data of the buffer set 5 to the secondary device 120 is started.

Also, in the event that the write-back of the buffer set 5 has been completed, staging is performed in which the buffer set data of the buffer set 5 is read out from the evacuation buffer 118 and stored in the buffer set 1.

FIGS. 32A and 32B are flowcharts illustrating the staging according to the present embodiment. The processing in FIGS. 32A and 32B is a specific illustrating of the processing in steps S2019a through S2021a in FIG. 20B.

In step 3200a, upon old generation releasing processing ending, the master control module at the primary device 110 transitions the processing to step S3201a.

In step S3201a, the master control module determines the generation for staging. For example, the master control module references stage pointer information, increments a generation stored in the stage pointer information by 1, and determines the incremented generation to be the new generation for staging. This generation for staging is referred to as “staging object generation”. Also, in the processing in FIGS. 32A and 32B, a buffer set which is obtained in step S2015a in FIG. 20B and used for staging is abbreviated to “staging destination” as appropriate.

In step S3202a, the master control module checks whether or not the staging destination region of the staging object generation is in release processing standby. In the event that the staging destination region is standing by for release (Yes in S3202a), the master control module transitions the processing to step S3203a.

In step S3203a, the master control module sets a generation, which is the staging object generation plus 1, as a new staging object generation. The master control module then transitions the processing to step S3202a.

On the other hand, in the event that the staging destination region is not standing by for release (No in S3202a), the master control module transitions the processing to step S3204a.

In step S3204a, the master control module checks whether or not the staging destination is undergoing transfer. In the event that the staging destination is undergoing transfer (Yes in S3204a), the master control module transitions the processing to step S3203a.

On the other hand, in the event that the staging destination is not undergoing transfer (No in S3204a), the master control module transitions the processing to step S3205a.

In step S3205a, the master control module checks whether or not the staging object generation is undergoing staging. In the event that the staging object generation is undergoing staging (Yes in S3205a), the master control module transitions the processing to step S3203a.

On the other hand, in the event that the staging object generation is not undergoing staging (No in S3205a), the master control module transitions the processing to step S3206a.

In step S3206a, the master control module checks whether or not the staging object generation is undergoing write-back. In the event that the staging object generation is undergoing write-back (Yes in S3206a), the master control module transitions the processing to step S3207a.

In step S3207a, the master control module interrupts its own write-back, and also commissions write-back interruption to the other control modules of the primary device 110.

In step S3201b, upon receiving the write-back interruption commission from the master control module, the control modules interrupt the write-back being performed. The control modules then notify the master control module to the effect that write-back has been interrupted.

In step S3208a the master control module checks whether or not a response has been received from all control modules which have been commissioned, and in the event that there is a control module from which a response has not been received (No in step S3208a), the processing of step S3208a is repeated.

In the event that determination is made in step S3208a that responses have been received from all control modules (Yes in step S3208a), the master control module transitions the processing to step S3209a, and staging ends.

On the other hand, in the event that determination is made in step S3206a that the staging object generation is not undergoing write-back (No in S3206a), the master control module transitions the processing to step S3210a.

In step S3210a, the master control module checks whether or not the staging destination is undergoing storage processing of write data or the like. In the event that determination is made that the staging destination is undergoing storage processing (Yes in S3210a), the master control module transitions the processing to step S3211a, and staging ends.

In the event that determination is made in step S3210a that the staging destination is not undergoing storage processing (No in S3210a), the master control module transitions the processing to step S3212a.

In step S3212a, the master control module checks whether or not a staging object generation has already been stored in the staging destination obtained in the processing in step S2015a in FIG. 20B.

In the event that a staging object generation has been stored in the staging destination (Yes in S3212a), the master control module transitions the processing to step S3217a and ends the staging. Also, in the event that a staging object generation has not been stored in the staging destination (No in S3212a), the master control module transitions the processing to step S3213a.

In step S3213a, the master control module obtains the number of buffer sets being used for staging and transfer. The master control module then compares the number of buffer sets in use for staging and transfer with the buffer threshold, and in the event that the number of buffer sets in use is equal to or greater than the buffer threshold (Yes in S3213a), the master control module transitions the processing to step S3217a and ends the staging. Also, in the event that the number of buffer sets in use is not equal to or greater than the buffer threshold (No in S3213a), the master control module transitions the processing to step S3214a.

In step S3214a, the master control module performs stoaging as to the staging object generation as follows.

The master control module calculates the address of an individual evacuation buffer regarding where the staging object generation is stored, from the evacuation buffer management table 500. The master control module then obtains, from the calculated address, buffer data, BIT, and buffer set information.

The master control module then stores the obtained buffer data, BIT, and buffer set information, in the buffer 201a of the buffer set indicated by the staging object buffer set ID, BIT storage unit 201b, and buffer set information storage unit 202. Similar processing is performed at each control module within the primary device 110.

Note that in the event that the evacuation buffer appropriated to the control module is a continuous address space, the head address of the individual evacuation buffer can be obtained by adding “(staging object generation−1)×individual evacuation buffer size” to the “storing head address of evacuation data” set in the evacuation buffer management table 500.

In step S3215a, the master control module commissions the other control modules to obtain the staging object generation from the evacuation buffer 118 and perform stating, the same as in step S3214a.

In step S3202b, the control modules perform staging as to the buffer set information and BIT as follows.

The control modules which have received a staging commission obtain, from individual evacuation buffers of the evacuation buffer 118 appropriated thereto, the BIT and buffer set information of the staging object generation regarding which there has been a commission from the master control module.

The control modules then store the BIT and buffer set information obtained from the evacuation buffer 118 to the BIT storage unit 201b and buffer set information storage unit 202 of each control module.

In step S3203b, the control modules reference the individual evacuation buffers of the evacuation buffer 118 appropriated to themselves, and determine whether or not there is buffer data of the staging object generation. In the event that there is buffer data of the staging object generation in the individual evacuation buffers of the evacuation buffer 118 (Yes in S3203b), the control modules perform staging of the buffer data (S3204b). Upon the staging being completed, the control modules perform a completion notification as to the master control module.

Also, in the event that there is no buffer data of the staging object generation in the individual evacuation buffers of the evacuation buffer 118 (No in S3203b), the control modules perform a completion notification as to the master control module.

In step S3216a, the master control module monitors completion notifications until having received responses from all commission control modules. Upon having received responses from all commission control modules (Yes in S3216a), the master control module transitions the processing to step S3217a, and ends the staging.

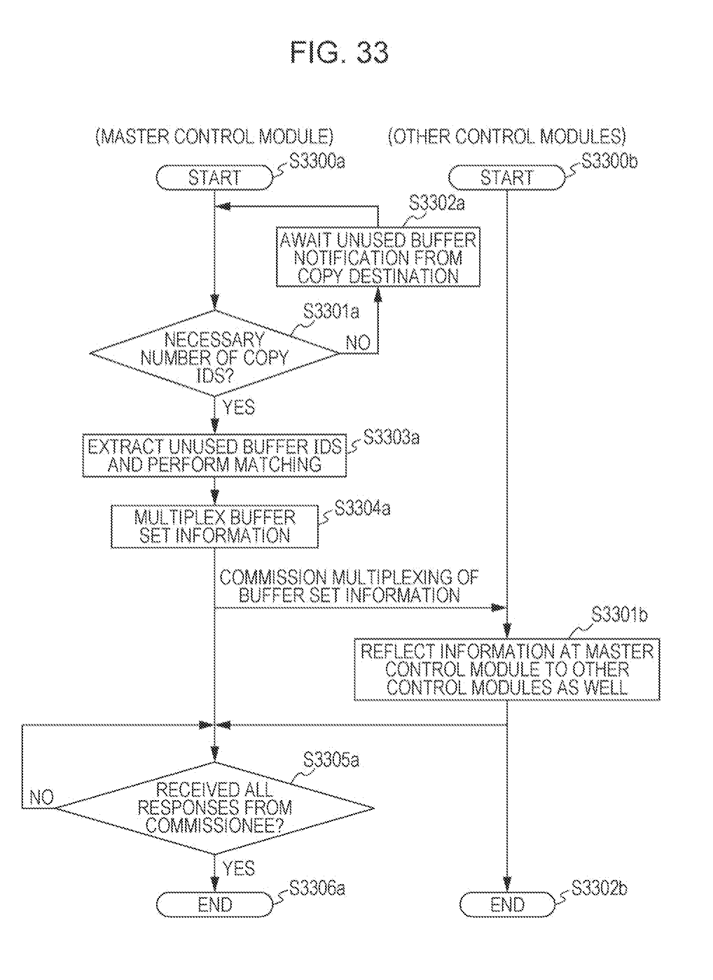

FIG. 33 is a flowchart illustrating specific processing of the matching processing in FIG. 20B (step S2012a). Note that in FIG. 33, specific processing is illustrated regarding the master control module of the primary device 110 and other control modules.

In step S3301a, the master control module makes reference to the unused buffer ID storage unit 206. The master control module confirms whether or not the number of unused buffer IDs stored in the unused buffer ID storage unit 206 is sufficient for matching with the copy source IDs included in the buffer set information stored in the buffer set information storage unit 202.

In the event that confirmation cannot be made in step S3301a that there is a sufficient number of unused buffer IDs (No in S3301a), the master control module transitions the processing to step S3302a. The master control module then stands by for unused buffer notification from the secondary device 120 in step S3302a, and upon receiving an unused buffer notification, transitions the processing to step S3301a.

On the other hand, in the event that confirmation is be made in step S3301a that there is a sufficient number of unused buffer IDs (Yes in S3301a), the master control module transitions the processing to step S3303a.

In step S3303a, the master control module obtains as many unused buffer IDs as needed from the unused buffer ID storage unit 206. The master control module then correlates the copy destination IDs included in the buffer set information already stored in the buffer set information storage unit 202 with the obtained unused buffer IDs, i.e., performs matching between the copy source buffers and copy destination buffers.

Upon this matching processing ending, the master control module notifies the other control modules of a multiplexing commission of buffer set information (step S3304a).

On the other hand, upon receiving the multiplexing commission of buffer set information from the master control module in step S3301b, the control modules perform multiplexing processing of buffer set information. This multiplexing processing of buffer set information is processing for holding the same buffer set information in all control modules of the primary device 110 or secondary device 120.

For example, the control modules obtain the buffer set information regarding which matching processing was performed in step S3303a from the master control module, and reflect the buffer set information that has been obtained in their own buffer set information storage units 202.

Upon the multiplexing processing of buffer set information in step S3301b ending, the control modules notify the master control module that the multiplexing processing of buffer set information has been completed.

In step S3305a, the master control module confirms whether responses have been received from all of the control modules regarding which multiplexing processing of buffer set information has been commissioned. In the event that determination is made that responses have been received from all control modules (Yes in S3305a), copy destination buffer appropriation processing is ended (step S3306a), and the processing transitions to step S2013a.

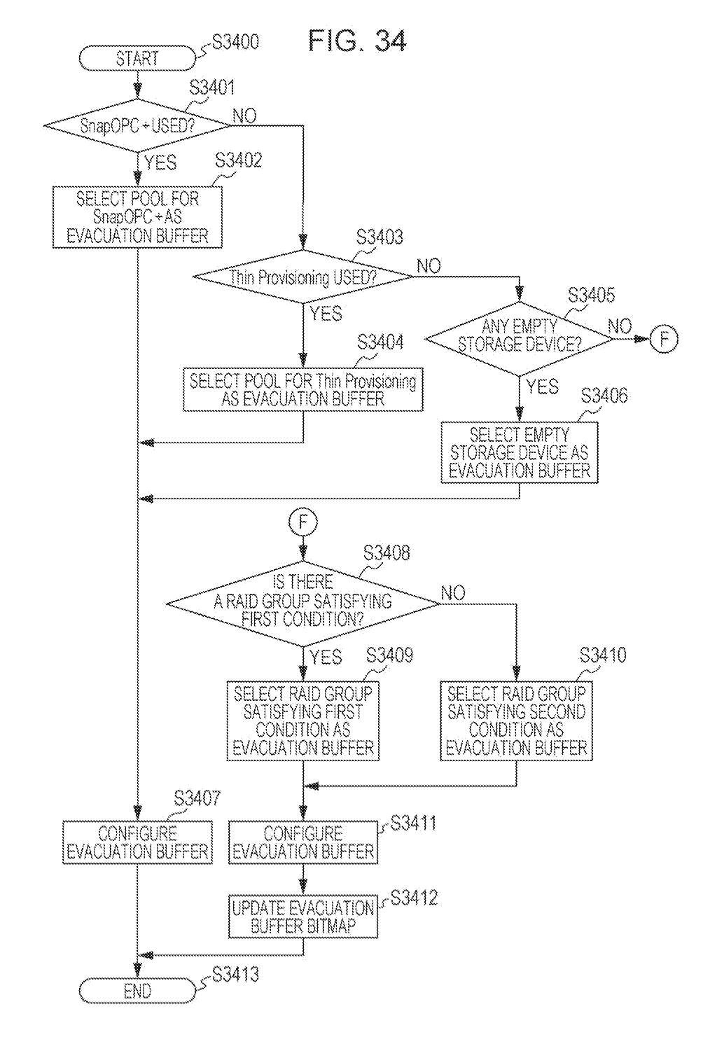

FIG. 34 is a flowchart illustrating processing of the secondary device 120 securing an evacuation buffer at the time of back remote copying according to the present embodiment (step S1908). Note that the processing in FIG. 34 is processing for securing an evacuation buffer in the event that an evacuation buffer 118 is not provided beforehand, as with the secondary device 120. Accordingly, cases of executing processing for securing an evacuation buffer are not restricted to when performing back remote copying. Also, in the event that the primary device 110 does not have an evacuation buffer 118 for example, it is needless to say that this is processing which is applicable to the primary device 110 as well.

For example, in the event that delay or the like occurs in the communication between the secondary device 120 and the primary device 110 for example, the secondary device 120 starts processing for securing the evacuation buffer 130 (step S3400).

In step S3401, the secondary device 120 confirms whether or not SnapOPC+ is used. Whether or not SnapOPC+ is used can be determined from, for example, configuration definition information defining the configuration of the secondary device 120, whether or not there is a pool for SnapOPC+ management table 800, and so forth.

In the event of using SnapOPC+ (Yes in step S3401), the secondary device 120 selects the pool for SnapOPC+ 128 as the destination for securing the evacuation buffer (step S3402). At this time, the secondary device 120 registers the storage region to be used as the evacuation buffer in the pool for SnapOPC+ management table 800.

Also, in the event that SnapOPC+ is not used (No in step S3401), the secondary device 120 confirms whether or not Thin Provisioning is used. Whether or not Thin Provisioning is used can be determined from, for example, configuration definition information defining the configuration of the secondary device 120, whether or not there is a pool for Thin Provisioning management table 1000, and so forth.

In the event of using Thin Provisioning (Yes in step S3403), the secondary device 120 selects the pool for Thin Provisioning 129 as the destination for securing the evacuation buffer (step S3404). At this time, the secondary device 120 registers the storage region to be used as the evacuation buffer in the pool for Thin Provisioning management table 1000.

Also, in the event that Thin Provisioning is not used (No in step S3403), the secondary device 120 confirms whether or not there is an empty storage device in the disk device 127 (step S3405). For example, the secondary device 120 makes reference to the disk device management table 600 and confirms whether or not there is a storage device set to unused.

Now, an empty storage device module a storage device of the storage devices such as magnetic disk devices of the disk device 127 what is not in a used state, for example, a storage device not assembled into the system of the secondary device 120. Note that empty storage devices may include a storage device which has been assembled into the secondary device 120 but has not bee prepared for read/write. Also, empty storage devices may include a storage device such as a magnetic disk device or the like provided to the secondary device 120 beforehand as a spare.

In the event that there is an empty storage device (Yes in step S3405), the secondary device 120 selects the empty storage device of the destination to secure the evacuation buffer (step S3406). Note that in the event that there are multiple empty storage devices, one may be arbitrarily selected as needed, or one may be selected based on criteria such as large storage capacity, a predetermined order of priority, or the like.

In step S3407, the secondary device 120 configures the evacuation buffer 130 at the storage device selected in the processing in steps S3402, S3404, or S3406. The processing of step S3407 and the later-described step S3411 is as shown in FIGS. 21 and 22.

On the other hand, in the event that there is no empty storage device (No in step S3405), the secondary device 120 confirms whether or not there is, of the RAID groups of the disk device 127 that are in use, a RAID group which has a low frequency of being updated, and a predetermined available capacity can be secured (step S3408).

Note that a “RAID group in use” module, of the RAID groups included in the disk device 127, a RAID group regarding which the user can perform read/write or is actually performing read/write. The storage region of a RAID group in such a state is called a “user region”.

In step S3408, the secondary device 120 conforms whether or not there is “a RAID group included the RAID groups of the disk device 127 that are in use, which has a low frequency of being updated, and a predetermined available capacity can be secured”. Hereinafter, the condition of “a RAID group included the RAID groups of the disk device 127 that are in use, which has a low frequency of being updated, and a predetermined available capacity can be secured” is referred to as a “first condition”.

For example, the secondary device 120 can extract a RAID group satisfying the first condition as follows.

The secondary device 120 makes reference to the update history information 1300, and confirms a copy range of an update point-in-time older than a predetermined update point-in-time. The secondary device 120 then extracts a RAID group of which copy ranges of an update point-in-time older than a predetermined update point-in-time account for a certain percentage or more, as a RAID group which has a low frequency of being updated. In this case, a RAID group is preferably extracted in which the update point-in-time copy ranges accounting for a certain percentage or more are older.

In the event that there is predetermined available capacity in the extracted RAID group, the extracted RAID group is selected as the destination to secure the evacuation buffer. As described above, in the event that there is a RAID group satisfying the first condition (Yes in step S3408), the secondary device 120 selects the RAID group satisfying the first condition as the as the destination to secure the evacuation buffer (step S3409). Also, in the event that there is no RAID group satisfying the first condition (No in step S3408), the secondary device 120 transitions the processing to step S3410.

In step S3410, the secondary device 120 selects, as the destination to secure the evacuation buffer, the RAID group of the RAID groups included in the disk device 127 and in use, which stores the same data as the primary device 110 and which has the storage region with the oldest update point-in-time. Hereinafter, the “RAID group of the RAID groups included in the disk device 127 and in use, which stores the same data as the primary device 110 and which has the storage region with the oldest update point-in-time”, is referred to as a “second condition”. Note that a “RAID group in use” refers to a RAID group which is in a state in which read/write of data is actually being performed, or in a state in which read/write of data can be performed.

For example, the secondary device 120 makes reference to the update history information 1300 and confirms the backup state. The secondary device 120 then extracts a copy range of update point-in-time older than a predetermined update point-in-time, from the copy range set as back-up completed in the update history information 1300. The secondary device 120 then selects the RAID group including the extracted copy range in a manner accounting for a certain percentage or more.

In step S3411, the secondary device 120 then configures the evacuation buffer 130 in the storage device selected in the processing in step S3409 or S3410. Configuration processing for the evacuation buffer 130 is as illustrated in FIGS. 21 and 22.

In step S3412, the secondary device 120 makes reference to the evacuation buffer bitmap 1200, and sets the state of the storage region to be used as the evacuation buffer 130 to “used”. At the same time, the secondary device 120 makes reference to the disk device bitmap 1100 sets the state of the storage region to be used as the evacuation buffer 130 to “unused”. The reason is that the storage region to be used as the evacuation buffer 130 is no longer used as a user region.

Upon the above processing ending, the secondary device 120 ends the processing for the secondary device 120 to secure an evacuation buffer at the time of back remote copying in FIG. 19 (step S3413).

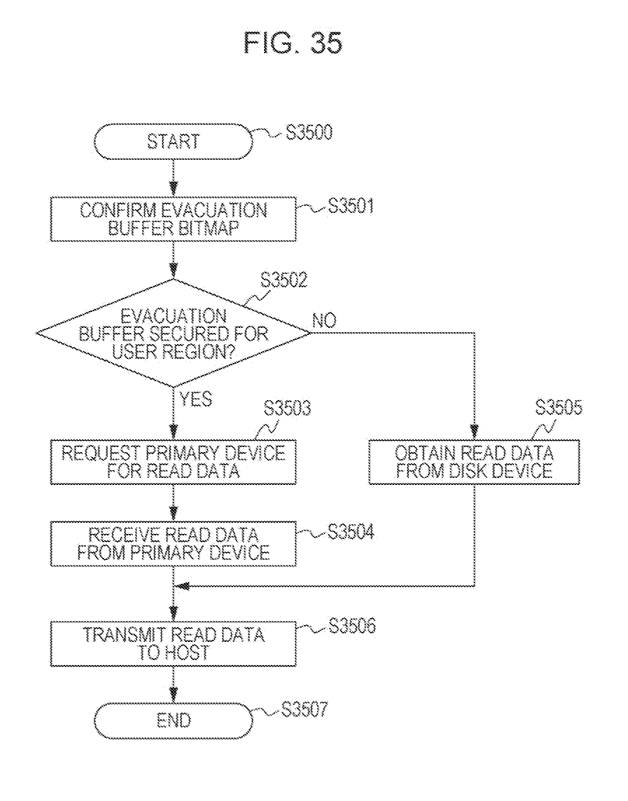

FIG. 35 is a flowchart illustrating read processing at the secondary device 120 according to the present embodiment.

Upon receiving a read I/O command from the host 150, the secondary device 120 transitions the processing to step S3501 and starts read processing. In the following description, data requested with a read I/O command is referred to as “read data”. Also, the head address of a storage region where read data is stored is referred to as a “read address”.

In step S3501, the secondary device 120 confirms whether or not the storage region of the read address is a storage region secured as the evacuation buffer 130 in the user region. The reason is that read data stored in a storage region where the evacuation buffer 130 has been secured in the user region has most likely been overwritten with evacuated data.

In step S3501, the secondary device 120 makes reference to the evacuation buffer bitmap 1200, and in the event that the storage region of the read address is “used”, this can be determined to be a storage region secured as the evacuation buffer 130 in the user region.

In the event that the storage region of the read address is storage region secured as the evacuation buffer 130 in the user region (Yes in step S3502), the secondary device 120 transitions the processing to step S3503. The secondary device 120 then requests the primary device 110 for read data (step S3503). The reason is that the data in the user region that has been remote-copied to the secondary device 120 is also held at the primary device 110.

Upon the read data being transmitted from the primary device 110, the secondary device 120 receives the read data (step S3504), and transmits the received read data to the host 150 (step S3506).

On the other hand, in the event that storage region of the read address is not a storage region secured as the evacuation buffer 130 in the user region (No in step S3502), the secondary device 120 obtains the read data from the disk device 127 (step S3505). The secondary device 120 then transmits the obtained read data to the host 150 (step S3506).

Upon ending the above processing, the secondary device 120 ends the read processing (step S3507).

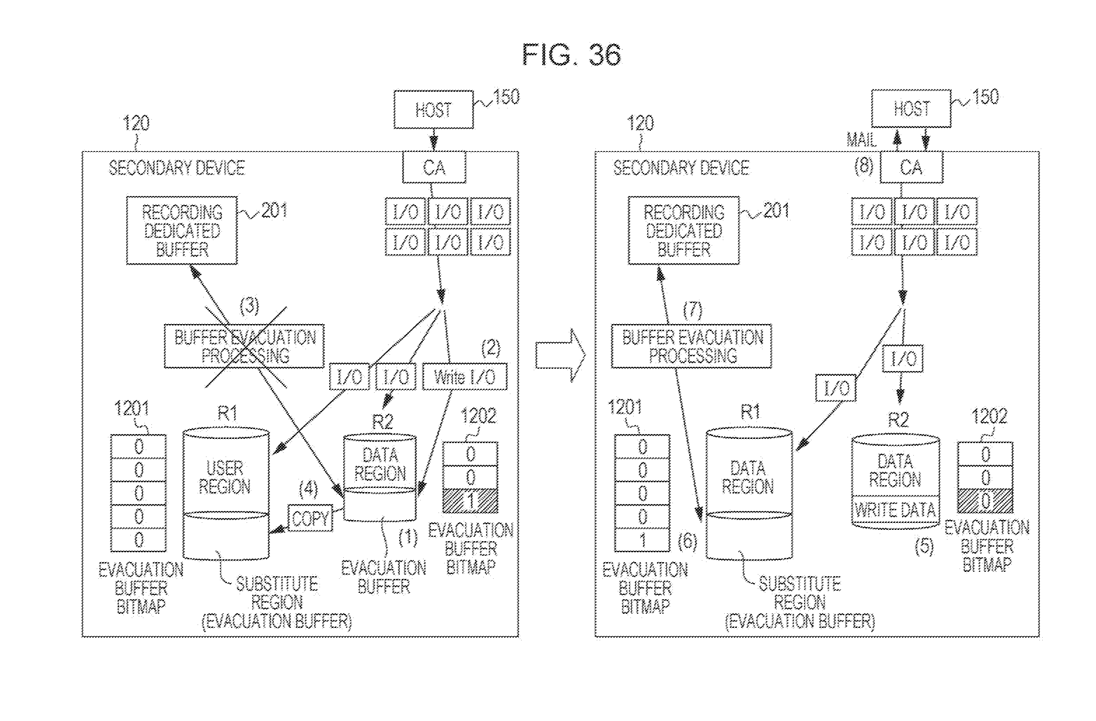

FIG. 36 is a diagram illustrating the overview of write processing at the secondary device 120 according to the present embodiment.

Note that in FIG. 36, the overview of write processing is described with reference to an example of a case in which the disk device 127 has two RAID groups R1 and R2. While the secondary device 120 in FIG. 36 has been illustrated with a simplified configuration to facilitate understanding of the description, this is not intended to restrict the configuration of the configuration to that shown in FIG. 3. Also, while evacuation buffer bitmaps 1201 and 1202 are shown for each RAID group to facilitate understanding of the description, it is needless to say that one evacuation buffer bitmap for the entire secondary device 120 is sufficient, as shown in FIG. 12.

The following (1) through (8) correspond to the (1) through (8) in FIG. 36.

(1) The RAID group R1 includes a user region, and the RAID group R2 includes a user region and an evacuation buffer 130 secured in the user region by the processing in FIG. 34. At this time, “1” is set to the evacuation buffer bitmap 1202 indicating that the storage region used as the evacuation buffer 130 is in use.

(2) The secondary device 120 receives an I/O command from the host 150. In some cases, the secondary device 120 receives a write I/O command to the evacuation buffer 130 stored in the RAID group R2.

(3) Upon receiving the write I/O command, the secondary device 120 stops buffer evacuation processing.

(4) The secondary device 120 then copies the evacuation buffer 130 secured in the user region of the RAID group R2, to the user region of the RAID group R1.

(5) Upon copying of the evacuation buffer 130 being completed, the secondary device 120 sets “0” to the evacuation buffer bitmap 1202, indicating that the storage region used as the evacuation buffer 130 is unused. The secondary device 120 then writes the write data to the RAID group R1.

(6) Also, the secondary device 120 sets “1” to the evacuation buffer bitmap 1201, indicating that the storage region of the evacuation buffer 130 copied to the RAID group R1 is in use.

(7) Upon moving the evacuation buffer 130 from the RAID group R2 to the RAID group R1 being completed, the secondary device 120 resumes buffer evacuation processing.

(8) The secondary device 120 then transmits mail to the host 150 to the effect that the evacuation buffer 130 has been moved, along with information of the storage region where the evacuation buffer 130 has been moved, and so forth.

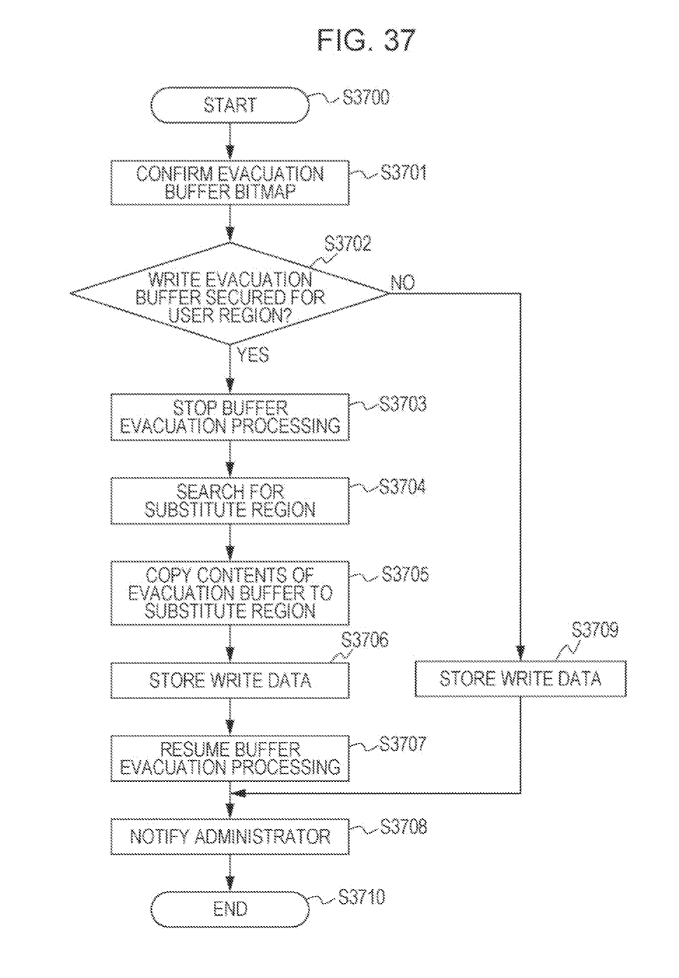

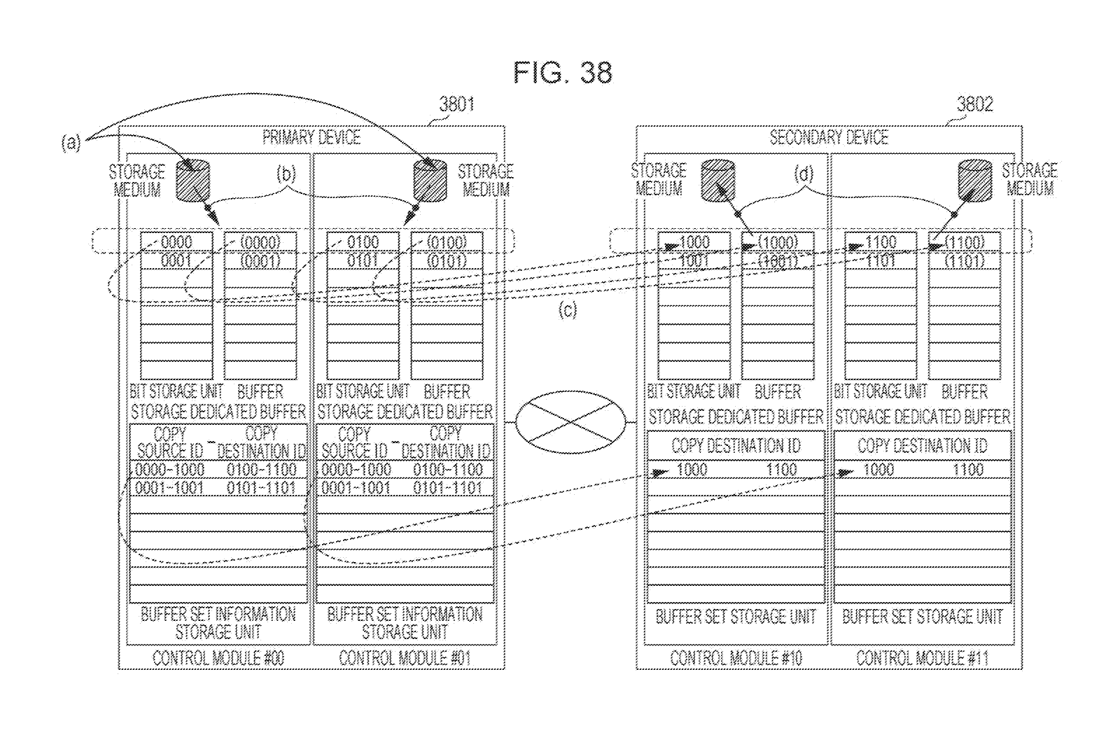

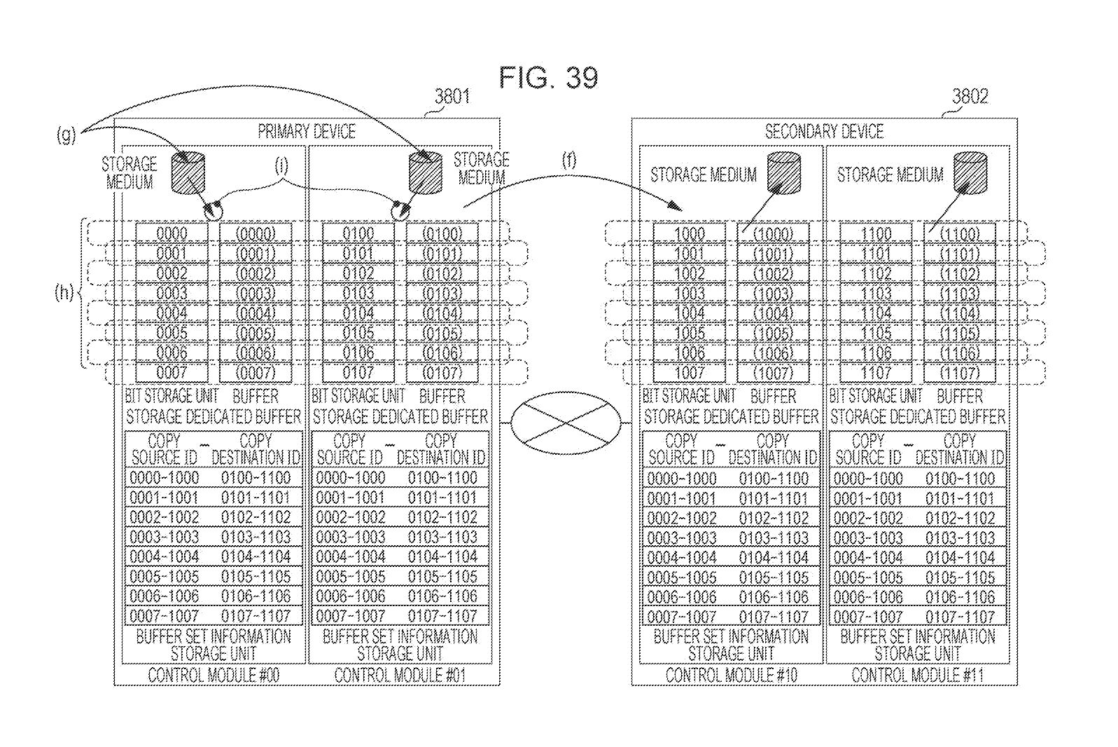

FIG. 37 is a flowchart illustrating the write processing of the secondary device 120 according to the present embodiment.

Upon receiving a write I/O command from the host 150, the secondary device 120 transitions the processing to step S3701 and starts write processing.

In step S3701, the secondary device 120 confirms whether or not he storage region of the write address is a storage region secured in the user region as an evacuation buffer 130. For example, the secondary device 120 makes reference to the evacuation buffer bitmap 1200, and in the event that the storage region of the write address is set to used, this can be determined to be a storage region secured in the user region as an evacuation buffer 130.

In the event that the storage region of the write address is a storage region secured in the user region as an evacuation buffer 130 (Yes in step S3702), the secondary device 120 stops buffer evacuation processing (step S3703).

In step S3704, the secondary device 120 searches for a substitute region for the evacuation buffer 130, secured in a part of the user region. With the present embodiment, a region satisfying the second condition shown in FIG. 34 is searched for from the RAID groups other than the RAID group currently in use as the evacuation buffer 130, and used as a substitute region.

Note however, that of the RAID groups other than the RAID group currently in use as the evacuation buffer 130, a region satisfying the first condition shown in FIG. 34 may be used as a substitute region.

In step S3705, the secondary device 120 copies the content of the evacuation buffer 130 to the substitute region that has been found. At this time, the secondary device 120 sets the address of the storage region which had been in use as the evacuation buffer 130 in the evacuation buffer bitmap 1200 to unused. Also, the secondary device 120 sets the address of the storage region in use as the substitute region in the evacuation buffer bitmap 1200 to used.

In step S3706, upon copying to the substitute region being completed, the secondary device 120 stores write data to the region of the evacuation buffer which the write address indicates. At this time, the secondary device 120 sets the write address in the disk device bitmap 1100, to used.

In step S3707, the secondary device 120 resumes the buffer evacuation processing. The secondary device 120 then uses email or the like to notify the administrator that substitution processing of the evacuation buffer 130 has been performed.

On the other hand, in the event that the storage region of the write address is not a storage region secured in the user region as an evacuation buffer 130 (No in step S3702), the secondary device 120 stores write data to the region of the evacuation buffer which the write address indicates. At this time, the secondary device 120 sets the write address in the disk device bitmap 1100, to used.

Upon the above processing ending, the secondary device 120 ends the write processing.

As described above, the primary device 110 has an evacuation buffer 118. In the event that the number of buffers in use for transfer/staging exceeds the buffer threshold during forward remote copying, the primary device 110 performs write-back, wherein the buffer set data is evacuated to the evacuation buffer 118.

For example, in the event that the line capabilities between the primary device 110 and the secondary device 120 are low, even if write I/O commands are received from the host 150 one after another the primary device 110 evacuates the buffer set data to the evacuation buffer 118 when the number of buffer sets in use exceeds the buffer threshold.

On the other hand, upon transfer and loading processing of the buffer set data to the secondary device 120 being completed, the primary device 110 releases the region where the buffer set data had been stored, and performs staging at the released region of the buffer set data which had been evacuated to the evacuation buffer 118. The primary device 110 then transfers the buffer data to the secondary device 120.

Thus, with the primary device 110 according to the present embodiment, even in the event that there is delay in data transfer processing such as the line capabilities between the primary device 110 and the secondary device 120 being low, depletion of buffer sets can be prevented. Accordingly, buffer halt processing performed at the time of depletion of buffer sets can be prevented. That is to say, the primary device 110 can prevent the contents of buffer sets from being cleared by buffer halt processing, and order-guaranteed remote copying from being interrupted. As a result, even in the event that there is delay in the data transfer processing, the primary device 110 can perform order-guaranteed remote copying.

Further, the same advantages can be obtained in cases of delay in data transfer processing from unstable line capabilities, the data update amount from write I/Os and the like exceeding the capacity of the recording dedicated buffer 201 of the primary device 110, and so forth.

With the secondary device 120 according to the present embodiment, in the event that delay or the like occurs between the primary device 110 and the secondary device 120 during back remote copying, owing to the line capabilities between the primary device 110 and the secondary device 120 being low, the secondary device 120 generates an evacuation buffer 130. In the event that the number of buffer sets in use for transfer/staging exceeding the buffer threshold in back remote copying, the secondary device 120 performs write-back so evacuate the buffer set data to the evacuation buffer 130.

On the other hand, upon transfer and loading processing of the buffer set data to the primary device 110 being completed, the secondary device 120 releases the region where the buffer set data had been stored, and performs staging at the released region of the buffer set data which had been evacuated to the evacuation buffer 130. The secondary device 120 then transfers the buffer data to the primary device 110.

Thus, in the same way as with the primary device 110, even in the event that there is delay in data transfer processing, the secondary device 120 can perform order-guaranteed remote copying. Further, the same advantages can be obtained in cases of delay in data transfer processing from unstable line capabilities, the data update amount from write I/Os and the like exceeding the capacity of the recording dedicated buffer 201 of the secondary device 120, and so forth.

Further, the secondary device 120 does not have a dedicated evacuation buffer like the primary device 110, so a storage region of a usable storage device of the secondary device 120 is used as the evacuation buffer 130.

In the event of using SnapOPC+ or Thin Provisioning or the like, the secondary device 120 uses a part of the pool for SnapOPC+ 128 or pool for Thin Provisioning management table 1000 as the evacuation buffer 130.

Also, in the event that there is an empty storage device, the secondary device 120 uses part or all of the empty storage device for the evacuation buffer 130.

Further, if there is no pool for SnapOPC+ 128, pool for Thin Provisioning management table 1000, empty storage device, or the like, the secondary device 120 uses part or all of a RAID group satisfying the first condition.

Further, in the event that there is not even a RAID group satisfying the first condition, part or all of a RAID group satisfying the second condition is used for the evacuation buffer 130.

Thus, even without providing a dedicated evacuation buffer beforehand, order-guaranteed remote copying can be performed in a more sure manner even in cases of delay in data transfer processing, by securing an evacuation buffer 130 as needed. Further, the same advantages can be obtained in cases of delay in data transfer processing from unstable line capabilities, the data update amount from write I/Os and the like exceeding the capacity of the recording dedicated buffer 201 of the secondary device 120, and so forth.

Increasing the storage capacity of the evacuation buffer 130 rather than increasing the storage capacity of memory to be used for the recording dedicated buffer 201 enables order-guaranteed remote copying at lower costs.

Also, as shown in FIG. 23, when storing write data in individual buffers at the time of performing remote copying, in the event that data of the same write address already exists in one of the individual buffers standing by for transfer, the write data is overwritten. Thus, storage processing to individual buffers can be efficiently performed without interrupting the order. As a result, the amount of data transferred between the primary device 110 and the secondary device 120 can be reduced, yielding the advantage of improved transfer capabilities of data when remote copying.

Also, with conventional forward remote copying, matching processing between the copy source IDs and copy destination IDs was performed at the time of creating buffer set information. However, with remote copy processing according to the present embodiment, this is not performed at the timing of step S2003a, but rather is performed after storage processing to the buffer is completed and immediately before performing transfer processing (step S2012a).

Accordingly, data storage processing can be performed to buffers other than buffers related to the transfer processing, in a manner parallel to the transfer processing, so all buffers of the primary device 110 including the recording dedicated buffer 201 and the buffer set information storage unit 202 can be used efficiently. For example, data relating to write I/Os from the host 150 can be stored until the buffer capacity of the primary device 110 runs out.

As a result, even in the event that the secondary device 120 has fewer buffers than the primary device 110 with regard to buffers used for order-guaranteed forward remote copying, buffers of the primary device 110 can be efficiently used.

From the same reason, with regard to the buffer used for order-guaranteed back remote copying, the buffer of the secondary device 120 can be used effectively even in the event that the buffer of the primary device 110 is smaller than the buffer of the secondary device 120.

Also, even in the event that some sort of trouble in the network between the primary device 110 and the secondary device 120 causes path obstruction, write data can be evacuated to evacuation buffers as long as the capacity permits. Accordingly, an advantage can be had in that, as long as the path obstruction can be resolved before buffer depletion, there is no more need to interrupt order-guaranteed remote copying.

What is claimed is:

1. A storage device comprising:
a first storage module including a storage region for storing data transmitted from a higher level device;
a plurality of second storage modules which temporarily store data;
a reception processing module which receives data transmitted from the higher level device;
a first storage processing module which stores data received from the higher level device in the first storage module, and stores data received from the higher level device in the second storage modules in a distributed manner following the order of reception;
a data group output module which outputs a data group including data stored in each of the plurality of second storage modules;
a data group storage region securing module which, upon detecting an abnormality in output processing by the data group output module, secures a data group storage region for storing the data group in the first storage module or in a third storage module;
an evacuation processing module which reads out the data group from the second storage modules and evacuates to the data group storage region, depending on the usage state of the second storage modules; and
a second storage processing module which stores the data group which has been evacuated to the data group storage region in a distributed manner in each storage region of the second storage modules which have become available due to output processing by the data group output module having been completed.

2. The storage device according to claim 1, wherein the data group storage region securing module selects a storage region not used as the first storage module among storage regions of a fourth storage module providing a virtual storage region in the first storage module, and secures the data group storage region in the selected storage region.

3. The storage device according to claim 1, wherein the data group storage region securing module selects the third storage module and secures the data group storage region in the third storage module.

4. The storage device according to claim 1, wherein the data group storage region securing module selects the storage region from one or multiple storage regions of the first storage module based on update frequency and available capacity of the storage region, and secures the data group storage region in the selected storage region.

5. The storage device according to claim 1, wherein the data group storage region securing module selects, a storage region with low update frequency and that stores data as same as the data held at the output destination of the data group output module among one or multiple storage regions of the first storage module, and secures the data group storage region in the selected storage region.

6. The storage device according to claim 1, wherein the first storage processing module searches second data to be stored in a storage position in which first data to be stored at the output destination from data stored in the second storage modules, and updates the second data with the first data upon detecting the second data.

7. A control device in a storage device, the storage device including a first storage module of which all or part of its storage region thereof is used as a storage module for storing data transmitted from a higher level device, and the storage device including a plurality of second storage modules for temporarily storing the data, the data being stored in the second storage module in a distributed manner, the control device being provided in the second storage modules for each, the control device comprising:
a reception processing module which receives data transmitted from the higher level device;
a first storage processing module which stores data received from the higher level device in the first storage module, and stores data received from the higher level device in the second storage modules in a distributed manner following the order of reception;
a data group output module which outputs a data group including data stored in each of the plurality of second storage modules, in batch fashion;
a data group storage region securing module which, upon detecting an abnormality in output processing by the data group output module, secures a data group storage region for storing the data group in the first storage module or third storage module;
an evacuation processing module which reads out the data group from the second storage modules and evacuates to the data group storage region, depending on the usage state of the second storage modules; and
a second storage processing module which stores the data group which has been evacuated to the data group storage region in a distributed manner in each storage region of the second storage modules which have become available due to output processing by the data group output module having been completed.

8. The storage device according to claims 7, further comprising a data group storage region moving module which secures a second data group storage region other than the first data group storage region in the first storage module upon write processing as to the first data group storage region occurs, and moves the data group storage region to the second data group storage region.

9. A method for controlling a storage device including a first storage module of which all or part of the storage region thereof is used as storage module for storing data transmitted from a high level device, and a plurality of second storage modules for temporarily storing data, the method comprising:
storing data received from the high level device into the first storage module, and storing the data received from the high level device into the second storage modules in a distributed manner in an order of the reception;
outputting a data group including data stored in each of the plurality of second storage modules in batch fashion,
a data group storage region for storing the data group in the first storage module or in a third storage module upon detecting an abnormality in the output processing,
reading out the data group from the second storage modules and evacuating the read out data group to the data group storage region, depending on the usage state of the second storage modules, and
storing the data group which has been evacuated to the data group storage region in each storage region of the second storage modules which have become available upon completion of the output processing in a distributed manner.

10. A storage device comprising:
first storage module using part of all of a storage region as storage module for storing data transmitted from another storage device for storing the data transmitted from a higher level device;
reception processing module which receive data transmitted from the higher level device;
first storage processing module which store data received from the higher level device in the first storage module;
second storage processing module which, in the event of detecting an abnormality in the other storage device, receive data transmitted from the higher level device, and store the received data in the first storage module;
a plurality of second storage modules which temporarily store data;
third storage processing module which, upon detecting recovery of the other storage device, store the data received from the higher level device in the first storage module, and also store data received from the higher level device in the second storage modules in a distributed manner following the order of reception;
data group output module which output a data group including data stored in each of the plurality of second storage modules, in batch fashion;
data group storage region securing module which, upon detecting an abnormality in output processing by the data group output module, secure a data group storage region for storing the data group in the first storage module or third storage module;
evacuation processing module which read out the data group from the second storage modules and evacuate to the data group storage region, depending on the usage state of the second storage modules; and
fourth storage processing module which store the data group, which has been evacuated to the data group storage region, in a distributed manner in each storage region of the second storage modules which have become available due to output processing by the data group output module having been completed.
